(19) United States
(12) Patent Application Publication
(10) Pub. No.: US 2012/0221943 A1
(43) Pub. Date: Aug. 30, 2012

(54) DISPLAY CONTROL METHOD, DISPLAY DEVICE AND ELECTRONIC APPARATUS

(75) Inventor: Yusuke YAMADA, Matsumoto-shi (JP)

(73) Assignee: SEIKO EPSON CORPORATION, Tokyo (JP)

(21) Appl. No.: 13/404,783

(22) Filed: Feb. 24, 2012

(30) Foreign Application Priority Data
Feb. 25, 2011 (JP) 2011-039880

(51) Int. Cl. G06F 17/00

(52) U.S. Cl. 715/243

(57) ABSTRACT

A display control method includes the steps of obtaining a plurality of thumbnail images for a document having a plurality of pages, the thumbnail images each presenting each of the plurality of pages reduced in size in a reference state, rotated about a virtual rotation axis as a center, and processed into a view overlooked from a certain viewpoint; obtaining a first search subject; obtaining a first tag image corresponding to the first search subject obtained; and displaying a thumbnail image group on a display device, the thumbnail image group including the plurality of thumbnail images in a state in which at least two thumbnail images among the plurality of thumbnail images are partially overlapped each other and the first tag image is added to a thumbnail image of a page including the first search subject.

### BACKGROUND

1. Technical Field

The present invention relates to methods for displaying thumbnail images for an electronic book, display devices, and electronic apparatuses.

2. Related Art

Technologies of conducting searches in electronic documents such as electronic books and displaying search results are known. For example, Japanese Laid-open Patent Application 2006-313485 (Patent Document 1) describes a method of arranging only pages appended with bookmarks in an array of thumbnails. Also, Japanese Laid-open Patent Application 2008-301502 (Patent Document 2) describes a method of arranging thumbnails of pages that are reduced in size.

However, Patent Document 1 and Patent Document 2 still entail a problem in that it is difficult to grasp the relation between a list of search results and the entire document.

### SUMMARY

In accordance with some aspects of the invention, there is provided a technology for presenting the relation between search results and the entire document in a more visually comprehensible manner.

In accordance with an aspect of the invention, a display control method includes: obtaining a plurality of thumbnail images for a document having a plurality of pages, the thumbnail images each presenting each of the plurality of pages reduced in size in a reference state, rotated about a virtual rotation axis as a center, and processed into a view overlooked from a certain viewpoint; obtaining a first search subject; obtaining a first tag image corresponding to the first search subject obtained; and displaying a thumbnail image group on a display device, the thumbnail image group including the plurality of thumbnail images in a state in which at least two thumbnail images among the plurality of thumbnail images are partially overlapped each other and the first tag image is attached to a thumbnail image of a page including the first search subject. According to the display control method described above, the search result and the entire document can be presented in a manner in which the relation between them can be more readily, visually comprehensible.

In a preferred embodiment, the tag image may be processed so as to be rotated from the reference state through the same angle of rotation as that of the corresponding thumbnail image about the rotation axis of the thumbnail image, and into a view overlooked from the viewpoint of the thumbnail image. By the display control method described above, the tag image consistent with the thumbnail image can be provided.

In another preferred embodiment, the display control method may include the steps of obtaining a second search subject, and obtaining a second tag image different from the first tag image, and the thumbnail image group may include the second tag image attached to a thumbnail image of a page that includes the second search subject. According to this display control method, the first search subject and the second search subject can be presented in a mutually distinguishable manner.

In accordance with still another preferred embodiment, the display control method may include the steps of receiving a selection of a first selected page from among the plurality of pages, and updating the thumbnail image group displayed on the display device upon receiving the selection. In an aspect, the interval between a thumbnail image of the first selected page and a thumbnail image of a page before or after the first selected page in the thumbnail image group after update may be wider than the interval between a thumbnail image of the first selected page and a thumbnail image of a page before or after the first selected page in the thumbnail image group before update. According to this display control method, the position of the first selected page can be indicated with respect to the entire document, and the relation between the search result and the entire document can be presented.

In accordance with a further preferred embodiment, a thumbnail image of the first selected page may be positioned at the foremost plane in the thumbnail image group. According to this display control method, the first selected page can be displayed in a large thumbnail image.

In accordance with another preferred embodiment, the thumbnail image of the first selected page may be rotated about the virtual rotation axis as a center in a direction opposite to the direction of rotation of a thumbnail image of a page before or after the first selected page about the virtual rotation axis as a center. According to this display control method, two consecutive pages including the first selected page can be presented in a state of opened facing pages.

In accordance with still another preferred embodiment, the display control method includes the steps of receiving a selection of a second selected page from among the plurality of pages, and updating the thumbnail image group displayed on the display device upon receiving the selection. In an aspect, the interval between a thumbnail image of the second selected page and a thumbnail image of a page before or after the second selected page in the thumbnail image group after update may be wider than the interval between a thumbnail image of the second selected page and a thumbnail image of a page before or after the second selected page in the thumbnail image group before update. According to this display control method, the position of the second selected page different from the first selected page can be indicated in the entire document, and the relation between the search result and the entire document can be presented.

In accordance with another preferred embodiment, the display device may have a plurality of pixels, and the display control method may include the steps of changing the gradation of the pixels by a write operation of applying a voltage to the pixels multiple times, comparing image data representative of an image to be newly displayed on the display device with scheduled image data representative of an image scheduled to be displayed on the display device by the write operation in progress, thereby judging pixels whose gradation is to be changed among the plurality of pixels, and the steps of starting the write operation for a pixel to reach a gradation defined by the image data, when the pixel that is determined to be the pixel whose gradation is to be changed is not in the write operation, and starting the write operation for a pixel to reach a gradation defined by the image data, after the write operation in progress is completed, when the pixel that is determined to be the pixel whose gradation is to be changed is in the write operation. According to this display control method, the display speed perceived by the user can be improved.

In accordance with another embodiment of the invention, a display apparatus includes a display device that displays an image; a thumbnail image obtaining device that obtains a plurality of thumbnail images for a document having a plurality of pages, the thumbnail images each presenting each of the plurality of pages reduced in size in a reference state, rotated about a virtual rotation axis as a center, and processed into a view overlooked from a certain viewpoint; a search subject obtaining device that obtains a first search subject; a tag image obtaining device that obtains a first tag image corresponding to the first search subject; and a display control device that displays a thumbnail image group on the display device, the thumbnail image group including the plurality of thumbnail images in a state in which at least two thumbnail images among the plurality of thumbnail images are partially overlapped each other and the first tag image is attached to a thumbnail image of a page including the first search subject. According to the display apparatus described above, the search result and the entire document can be presented in such a manner that the relation between them can be more readily, visually comprehensible.

Further, in accordance with another embodiment of the invention, an electronic apparatus having the display device described above is provided. According to the electronic apparatus, the search result and the entire document can be presented in such a manner that the relation between them can be more readily, visually comprehensible.

### BRIEF DESCRIPTION OF THE DRAWINGS

FIG. 1 is a perspective view showing the external appearance of an electronic apparatus 1000.

FIG. 2 is a block diagram showing the hardware structure of the electronic apparatus 1000.

FIG. 3 is a schematic view of a cross-sectional structure of a display section 1.

FIG. 4 is a circuit diagram of the display section 1.

FIG. 5 is a diagram showing an equivalent circuit of a pixel 62.

FIG. 6 is a view showing the functional configuration of the electronic apparatus 1000.

FIG. 7 is a flow chart showing a thumbnail display processing.

FIGS. 8A-8E are views for describing a thumbnail image transforming processing.

FIG. 9 is a view showing an example of the interval d.

FIG. 10 is a view showing an example of a display image.

FIG. 11 is a flow chart showing a page display update processing.

FIG. 12 is a view showing an example of a display image.

FIG. 13 is a flow chart showing a search processing in an electronic book.

FIG. 14 is a view showing an example of a tag image.

FIGS. 15A-15E are views for describing a tag image deforming processing.

FIG. 16 is a view showing an example of a displayed image including tag images.

FIG. 17 is a flow chart showing a process of displaying a thumbnail image group including a second selected page.

FIG. 18 is a view showing an example of a thumbnail image group including the second selected page.

FIG. 19 is a block diagram showing a functional configuration of a controller 2.

FIG. 20 is a flow chart showing a drive processing of a display section 1 by the controller 2.

FIG. 21 is a view showing examples of data stored in memories.

FIG. 22 is a view showing an example of a state in which VRAM 4 is rewritten.

FIG. 23 is a view showing an example of a state in which data in the memory region B11 is rewritten.

FIG. 24 is a view showing an example of a state in which data in the memory region B12 is rewritten.

FIG. 25 is a view showing an example of a state in which data for the entire pixels have been rewritten.

FIG. 26 is a view showing an example of a state in which voltage applications for one frame have been conducted after the state shown in FIG. 25.

FIG. 27 is a view showing an example of a state in which rewriting of data in write data memory regions is completed.

FIG. 28 is a view showing an example of a state immediately after the processing in step S23 has been performed for the second time.

FIG. 29 is a view showing an example of a state in which data in VRAM 4 are rewritten.

FIG. 30 is a view showing an example of a state in which data rewriting has been completed for the entire pixels.

FIG. 31 is a view showing an example of a state in which the processing in step S23 is performed.

FIG. 32 is a view showing an example of a state in which voltage applications in a predetermined number of times have been completed.

FIG. 33 is a view showing an example of a state in which data rewriting has been completed for the entire pixels.

FIG. 34 is a view showing an example of a state in which the pixels have been rewritten.

FIG. 35 is a view showing an example of a state in which the process has advanced by one frame from the state shown in FIG. 34.

FIG. 36 is a view showing an example of a state in which the process has advanced from the state shown in FIG. 35.

FIG. 37 is a view showing an example of a display image in accordance with a modified example 3.

FIG. 38 is a view showing an example of an arrangement of thumbnail images in accordance with a modified example 4.

FIG. 39 is a view showing an example of a thumbnail image group in accordance with a modified example 6.

FIG. 40 is a view showing an example of a thumbnail image group in accordance with a modified example 7.

### DESCRIPTION OF EXEMPLARY EMBODIMENTS

### 1. Configuration

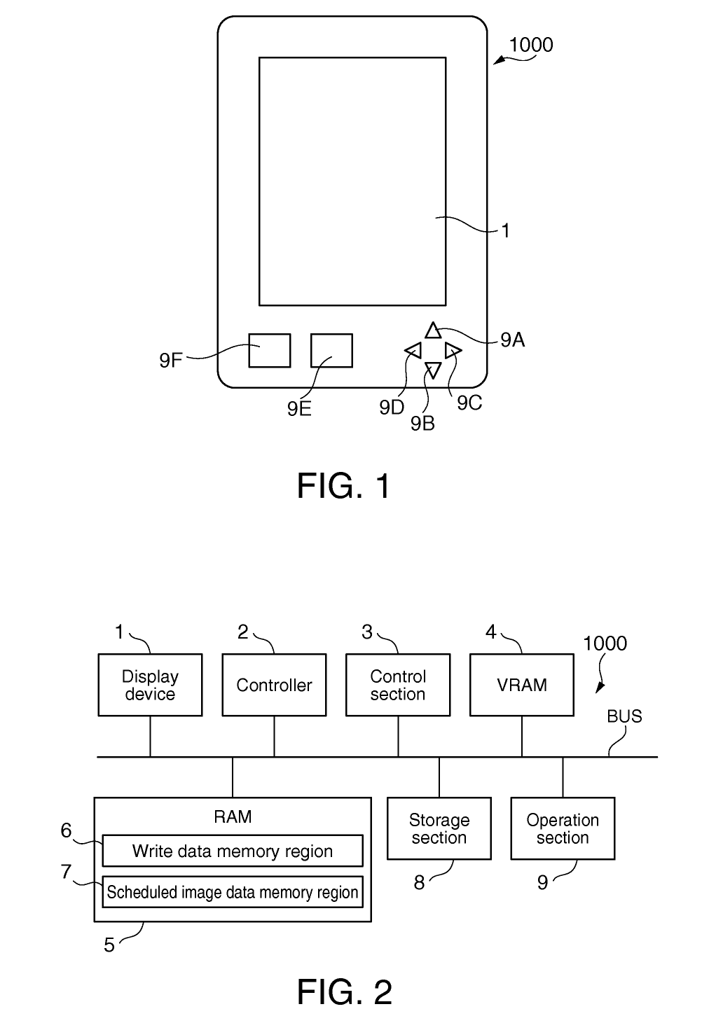

FIG. 1 is a view showing the external appearance of an electronic apparatus 1000 in accordance with an embodiment. The electronic apparatus 1000 is a display device that displays images. In this example, the electronic apparatus 100 is a device for reading electronic books (an example of documents), in other words, an electronic book reader. The electronic book is composed of data including multiple pages of images. The electronic apparatus 1000 displays the electronic book in a predetermined unit (for example, in the unit of one page) on a display section 1. Among the multiple pages included in the electronic book, one page that is subject to display is referred to as the “first selected page.” The first selected page may be changed in response to operation of buttons 9A-9F by the user. In other words, the user can turn pages of the electronic book (turning pages forward or turning pages backward) by operating the buttons 9A-9F. In accordance with the present embodiment, the electronic apparatus 1000 is capable of displaying images of reduced pages (hereafter referred to as “thumbnail images”), in addition to an image of the first selected page.

FIG. 2 is a block diagram showing a hardware configuration of the electronic apparatus 1000. The electronic apparatus 1000 includes a display section 1, a controller 2, a control section 3, a VRAM (Video Random Access Memory) 4, a RAM (Random Access Memory) 5, a storage section 8, an operation section 9, and a bus BUS. The display section 1 has a display panel including display elements for displaying an image. In this example, the display elements include display elements using electrophoretic particles, as display elements having the memory-property that retains a display state without supplying energy through voltage application or the like. The display section 1 displays an image in monochrome multiple gradation levels (in this example, two gradation levels of black and white) with the display elements. The controller 2 controls the display section 1. The control section 3 is a device that controls each of the sections of the electronic apparatus 1000, such as, a microcomputer having a CPU (Central Processing Unit), a ROM (Read Only Memory) and a RAM. The CPU uses the RAM as a work area, and executes a program stored in the ROM or the storage section 8. The VRAM 4 is a memory that stores image data indicative of an image to be displayed on the display section 1. The RAM 5 is a memory that stores data. In this example, the RAM 5 includes a write data memory region 6 that stores write data, and a scheduled image data memory region 7 that stores scheduled image data. The write data and the scheduled image data will be discussed later in detail. The storage section 8 is a nonvolatile memory that stores data of electronic books. The storage section 8 is capable of storing data of a plurality of electronic books. The operation section 9 is an input device for inputting user's instructions, and includes, for example, a touch screen, key pads, buttons or the like. The buttons 9A-9F shown in FIG. 1 are one of concrete examples of the operation section 9. The bus BUS is a transmission path for transmitting data or signals among the components.

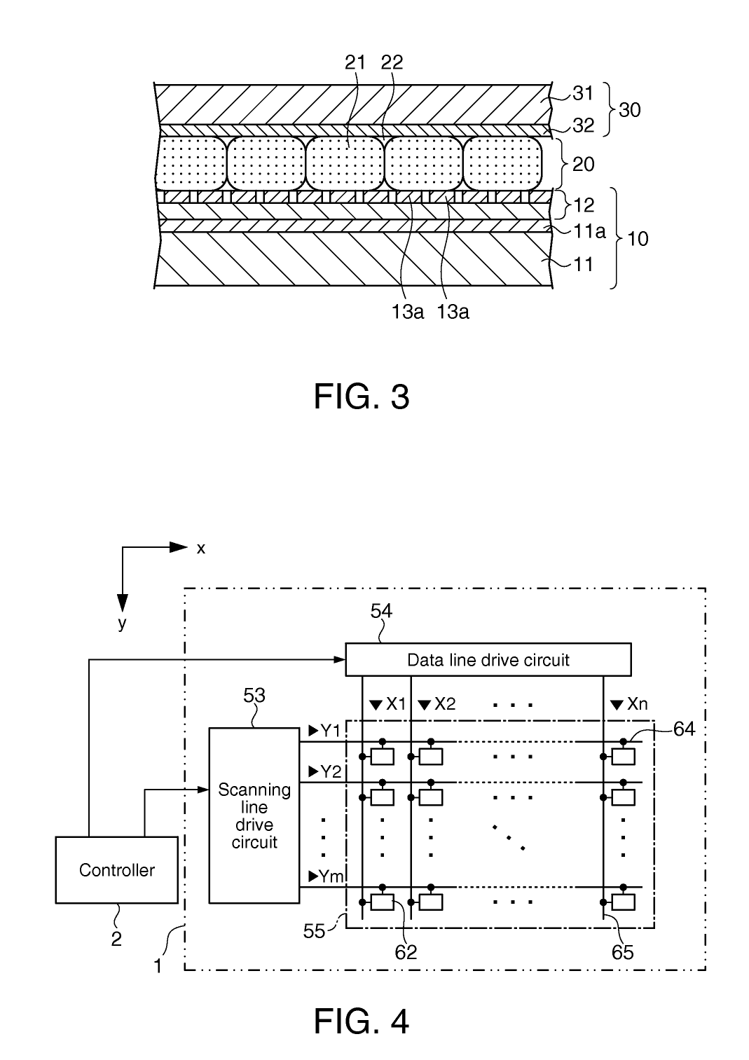

FIG. 3 is a schematic view of a cross⁻sectional structure of the display section 1. The display section 1 includes a first substrate 10, an electrophoretic layer 20, and a second substrate 30. The first substrate 10 and the second substrate 30 are substrates for retaining the electrophoretic layer 20.

The first substrate 10 includes a substrate 11, a bonding layer 11a and a circuit layer 12. The substrate 11 is made of a material having dielectric property and flexibility, for example, a polycarbonate substrate. It is noted that the substrate 11 may be made of any resin material that is light-weight, flexible, elastic and dielectric, without any particular limitation to polycarbonate. As another example, the substrate 11 may be formed from glass material without flexibility. The bonding layer 11a is a layer that bonds the substrate 11 and the circuit layer 12 together. The circuit layer 12 is a layer having a circuit for driving the electrophoretic layer 20. The circuit layer 12 has pixel electrodes 13a.

The electrophoretic layer 20 includes a binder 22 and microcapsules 21. The microcapsules 21 are fixed by the binder 22. The binder 22 may be made of any material that has good affinity with the microcapsules 21, excellent adhesion to the electrodes, and dielectric property. Each of the microcapsules 21 is a capsule containing a dispersion medium and electrophoretic particles. The microcapsules 21 may preferably be composed of a material having flexibility, such as, composites of gum arabic and gelatin, urethane compounds, and the like. It is noted that an adhesive layer made of adhesive may be provided between the microcapsules 21 and the pixel electrodes 13a.

As the dispersion medium, it is possible to use any one of materials including water; alcohol solvents (such as, methanol, ethanol, isopropanol, butanol, octanol, and methyl cellosolve); esters (such as, ethyl acetate and butyl acetate); ketones (such as, acetone, methyl ethyl ketone, and methyl isobutyl ketone); aliphatic hydrocarbons (such as, pentane, hexane, and octane); alicyclic hydrocarbons (such as, cyclohexane and methylcyclohexane); aromatic hydrocarbons (such as, benzene, toluene, long-chain alkyl group-containing benzenes (such as, xylenes, hexylbenzene, heptylbenzene, octylbenzene, nonylbenzene, decylbenzene, undecylbenzene, dodecylbenzene, tridecylbenzene, and tetradecylbenzene); halogenated hydrocarbons (such as, methylene chloride, chloroform, carbon tetrachloride, and 1,2-dichloroethane); and carboxylates. Also, the dispersion medium may be made of any one of other various oils. The dispersion medium may use any of the materials described above in combination, and may be further mixed with a surfactant.

The electrophoretic particles are particles (polymer or colloid) having a property in which the particles move in the dispersion medium by electric fields. In the present embodiment, white electrophoretic particles and black electrophoretic particles are contained in each of the microcapsules 21. The black electrophoretic particles are particles made of black pigments, such as, for example, aniline black, carbon black and the like, and are positively charged in the present embodiment. The white electrophoretic particles are particles made of white pigment, such as, for example, titanium dioxide, aluminum oxide and the like, and are negatively charged in the present embodiment.

The second substrate 30 includes a film 31 and a transparent electrode layer 32. The film 31 seals and protects the electrophoretic layer 20. The film 31 may be formed from a material that is transparent and has a dielectric property, for example, polyethylene terephthalate. The transparent electrode 32 is made of a transparent conductive material, such as, for example, indium tin oxide (ITO).

FIG. 4 is a diagram showing a circuit configuration of the display section 1. The display section 1 includes m scanning lines 64, n data lines 65, m x n pixels 62, a scanning line drive circuit 53, and a data line drive circuit 54. The scanning line drive circuit 53 and the data line drive circuit 54 are controller by the controller 2. The scanning lines 64 are arranged along a row direction (x direction), and transmit a scanning signal. The scanning signal is a signal that sequentially, exclusively selects one scanning line 64 from among the m scanning lines 64. The data lines 65 are arranged along a column direction (y direction), and transmit data signals. The data signals are signals indicative of gradation levels of each pixel. The scanning lines 64 are insulated from the data lines 65. The pixels 62 are provided at positions corresponding to intersections between the scanning lines 64 and the data lines 65, and exhibit gradations according to the respective data signals. It is noted that, when one scanning line 64 among the plurality of scanning lines 64 needs to be distinguished from the others, it is called the scanning line 64 in the first row, the second row, . . . , or the m^{-th} row. The data lines 65 may be similarly distinguished.

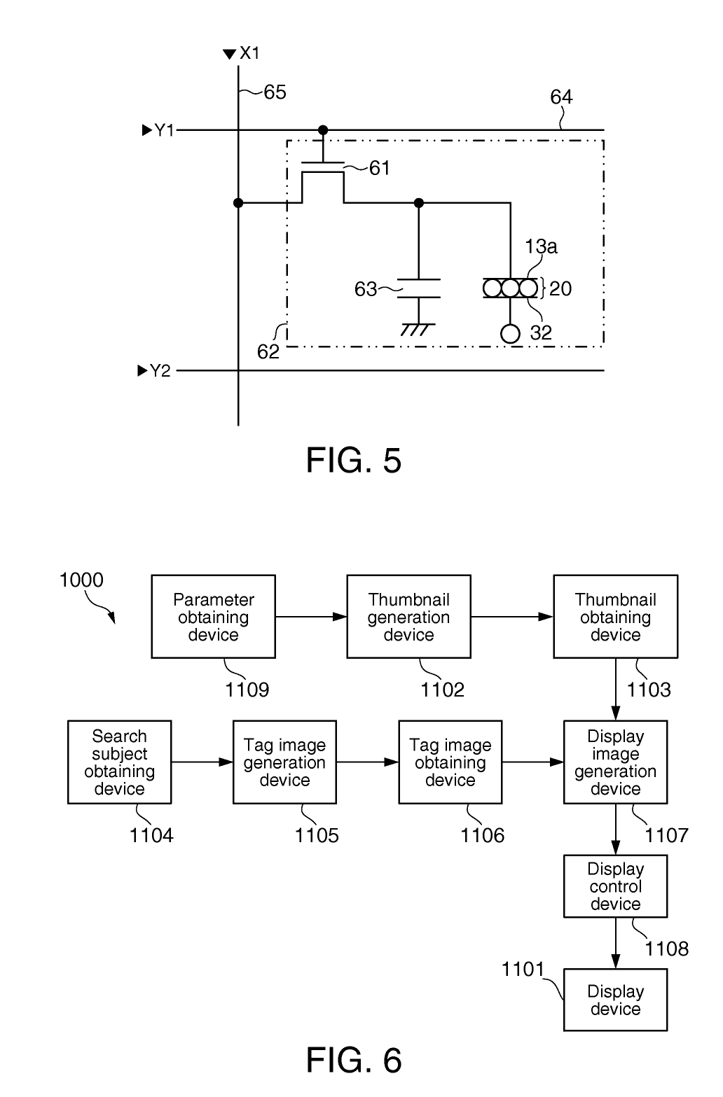

FIG. 5 is a diagram showing an equivalent circuit of the pixel 62. The pixel 62 includes a transistor 61, a retention capacitance 63, a pixel electrode 13a, an electrophoretic layer 20, and a transparent electrode 32. The transistor 61 is a switching element for controlling writing data to the pixel electrode 13a, for example, an n-channel TFT (Thin Film Transistor). The transistor 61 includes a gate, a source and a drain, connected to the scanning line 64, the data line 65 and the pixel electrode 13a, respectively. A scanning signal at L (Low) level (non-selection signal) is inputted in the gate, the source and the drain of the transistor 61 are insulated from each other. When a scanning signal at H (High) level (selection signal) is inputted in the gate, the source and the drain of the transistor 61 become conductive to each other, and a data voltage (a voltage indicative of the data signal) is written to the pixel electrode 13a. Also, the drain of the transistor 61 connects to the retention capacitance 63. The retention capacitance 63 retains a charge according to the data voltage. The pixel electrode 13a is provided at each of the pixels 62, and disposed opposite the transparent electrode 32. The transparent electrode 32 is commonly shared by the entire pixels 62, and is given a potential Vcom. The electrophoretic layer 20 is held between the pixel electrode 13a and the transparent electrode 32. A voltage corresponding to a potential difference between the pixel electrode 13a and the transparent electrode 32 is applied to the electrophoretic layer 20. In the microcapsules 21, the electrophoretic particles move according to a voltage applied to the electrophoretic layer 20, thereby expressing a gradation. For example, when the potential on the pixel electrodes 13a is positive (for example, +15V) with respect to the potential Vcom on the transparent electrode 32, the negatively charged white electrophoretic particles move toward the pixel electrode 13a, and the positively charged black electrophoretic particles move toward the transparent electrode layer 32. As the display section 1 is viewed from the side of the second substrate 30, the pixels appear in black. When the potential on the pixel electrodes 13a is negative (for example, −15V) with respect to the potential Vcom on the transparent electrode layer 32, the positively charged black electrophoretic particles move toward the pixel electrodes 13a, and the negatively charged white electrophoretic particles move toward the transparent electrode layer 32. In this instance, the pixels appear in white.

In the following description, a period starting from the selection of the scanning line in the 1^{st} row by the scanning line drive circuit 53 until the completion of the selection of the scanning line in the m-th row is referred to as a “frame period” or, simply a “frame.” Each of the scanning lines 64 is selected once in each frame, and a data signal is supplied to each of the pixels 62 once in each frame.

FIG. 6 is a diagram showing a functional configuration of the electronic apparatus 1000. The electronic apparatus 1000 includes a display device 1101, a thumbnail generation device 1102, a thumbnail obtaining device 1103, a search subject obtaining device 1104, a tag image generation device 1105, a tag image obtaining device 1106, a display image generation device 3 1107, and a display control device 1108. The display device 1101 displays an image. A parameter obtaining device 1109 obtains parameters, regarding a subject electronic book, for generating thumbnail images or display images. The thumbnail generation device 1102 generates thumbnail images for an electronic book having multiple pages. The thumbnail generation device 1102 reduces each of the pages into a reference state, rotates each of the pages about a virtual rotation axis as a center, and processes the pages into a view overlooked from a certain viewpoint. The thumbnail obtaining device 1103 obtains thumbnail images from the thumbnail generation device 1102. The search subject obtaining device 1104 obtains a first search subject. The tag image generation device 1105 generates a first tag image corresponding to the first search subject obtained by the search subject obtaining device 1104. The tag image obtaining device 1106 obtains the first tag image from the tag image generation device 1105. The display image generation device 1107 generates an image (a thumbnail image group) to be displayed. The thumbnail image group includes a plurality of thumbnail images and a first tag image. In the thumbnail image group, at least two thumbnail images among the plurality of thumbnail images are in a state being partially overlapped each other. The first tag image is added to a thumbnail image of a page that includes the first search subject.

The functions shown in FIG. 6 are achieved by a program for displaying thumbnail images executed by the control section 3. The display section 1 controlled by the control section 3 that executes the program is an example of the display device 1101. The control section 3 that executes the program is an example of the thumbnail generation device 1102, the thumbnail obtaining device 1103, the search subject obtaining device 1104, the tag image generation device 1105, the tag image obtaining device 1106, and the display image generation device 1107. The controller 2 controlled by the control section 3 that executes the program is an example of the display control device 1108.

### 2. Operation

### 2-1. DISPLAY OF THUMBNAIL IMAGES

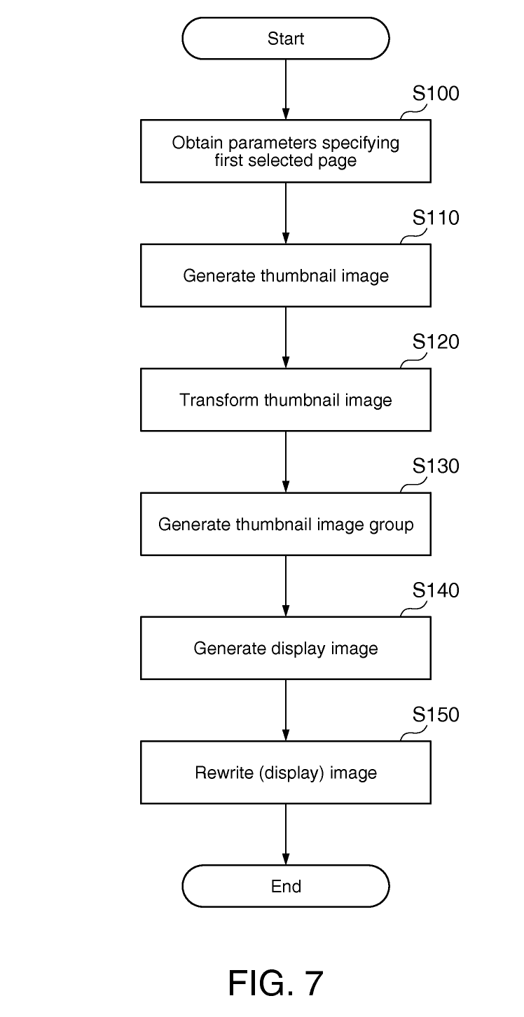

FIG. 7 is a flow chart showing a thumbnail display process in the electronic apparatus 1000. The processing flow shown in FIG. 7 is started with a predetermined event as a trigger, for example, a user's input of an instruction to perform a thumbnail display, in a state in which an image of a first selected page is displayed. In step S100, the control section 3 obtains parameters, regarding book data of a subject electronic book, to be used for transforming (generating) thumbnail images and for generating a display image. The parameters are stored in the RAM 5. The control section 3 reads the parameters from the RAM 5. The parameters include a parameter SP1 that specifies a first selected page. For example, when SP1=10, the parameter indicates that the 10^{th} page of the electronic book is selected.

In step S110, the control section 3 generates thumbnail images. More specifically, the control section 3 reduces data of each of the pages included in the book data by a predetermined reduction rate, thereby generating thumbnail images. The control section 3 stores the generated thumbnail images in the RAM 5. In step S120, the control section 3 transforms the thumbnail images.

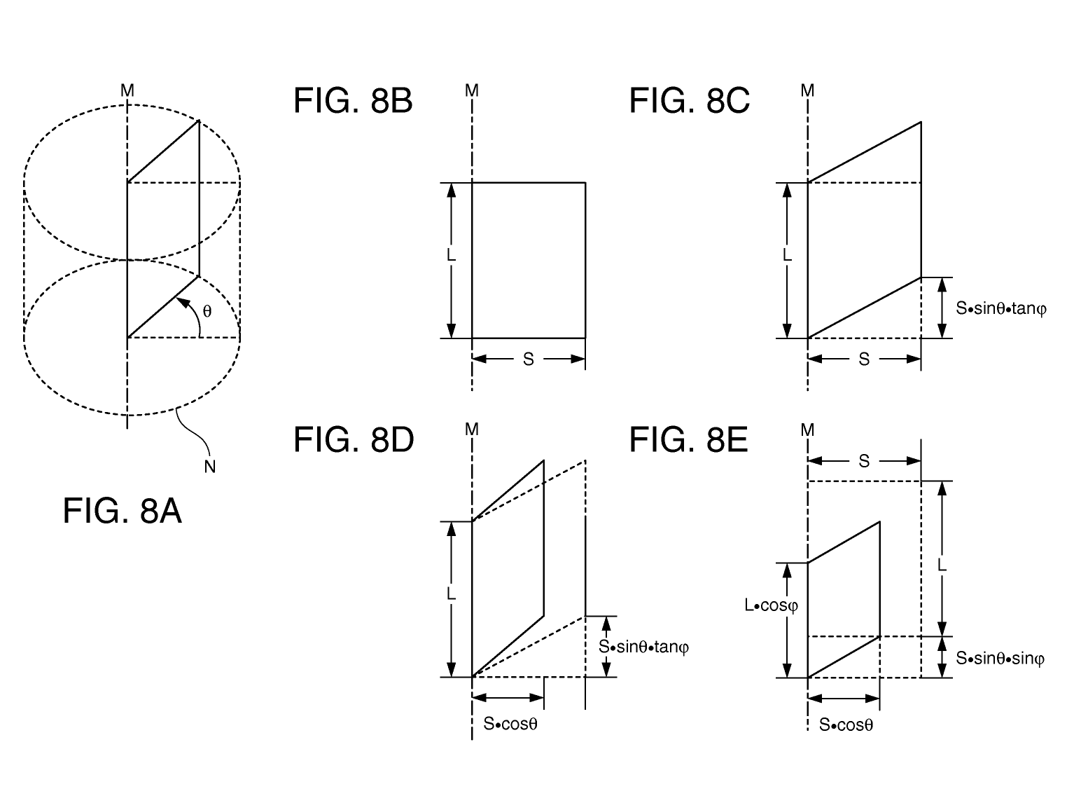

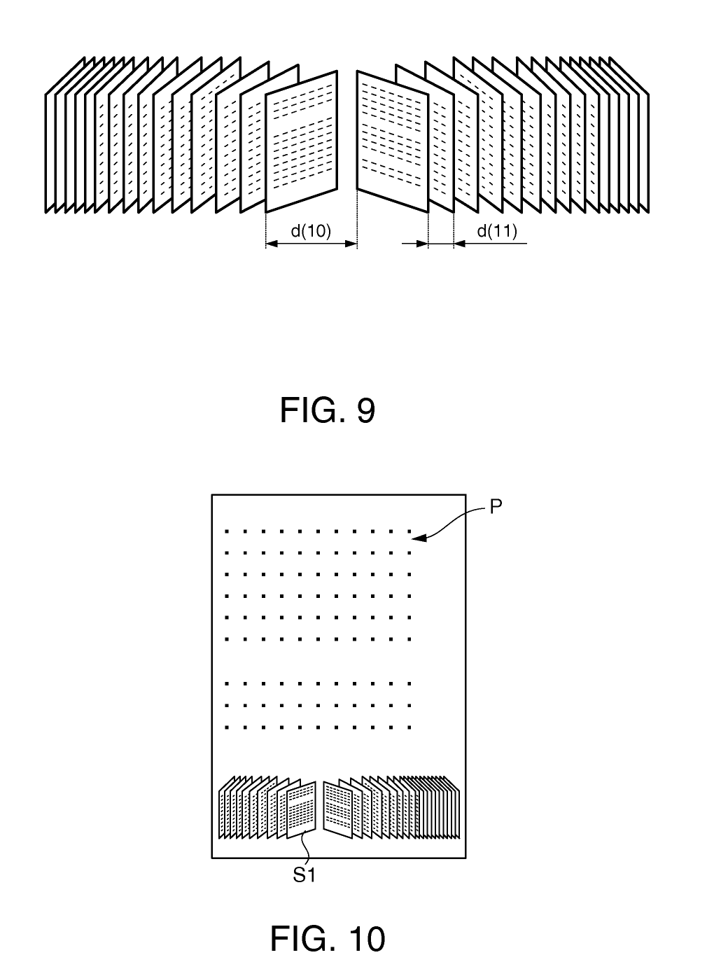

FIGS. 8A-8E are views for describing the process of transforming thumbnail images. Each of the thumbnail images generated in step S110 is an image of a page seen in a plan view. This state is hereunder referred to as a “reference state.” FIG. 8A is a view showing an example of a thumbnail image after transformation. The thumbnail image after transformation is an image of a page (a thumbnail image) erected upright on a horizontal plane N within a virtual space, and rotated about a virtual rotation axis M (a left side of the page in this example) as a center through an angle of rotation θ from the reference state. The angle of the horizontal plane N (a deviation of an oval shown by a broken line in the figure from a precise circle) depends on an angle of depression φ with respect to the page as viewed from a viewpoint above the upper side of the page within the virtual space. For example, when the page is viewed directly above the upper side, the oval indicated by a broken line becomes a precise circle. As the viewpoint lowers from there, the oval gradually becomes flatter. In this example, the angle of depression φ is decided in advance. The angle of rotation θ is decided according to the parameter SP1. In this example, the angle of rotation θ satisfies the following conditions. Parentheses show concrete example in the case of SP1 =10.

(1) The sign of the angle of rotation θ is different between the first selected page and its preceding page group and a page next to the first selected page and its succeeding page group. More specifically, θ>0 in the first selected page and its preceding page group, and θ<0 in a page next to the selected page and its succeeding page group. (Example: θ>0 in the 10^{th} page, and θ<0 in the 11^{th} page and its succeeding page group). It is noted that, in this example, the counterclockwise direction in FIG. 8A is the forward direction). In other words, the direction of rotation of the thumbnail image of the first selected page about the virtual rotation axis as a center is opposite to the direction of rotation of a page next to the first selected page and its succeeding page group.

(2) The angle of rotations θ of the first selected page and the page next to the first selected page have different signs, but the same magnitude (Example: θ=30° at the 10^{th} page, and θ=−30° at the 11^{th} page).

(3) In principle, with respect to two adjacent pages, the angle of rotation of one of the pages located closer to the first selected page is less than the angle of rotation of the other of the pages located farther to the first selected page (Example: θ=−30° at the 11^{th} page, and θ=−35° at the 12^{th} page).

(4) The angle of rotation is less than 90°. In other words, 0≦|θ|<90°.

Transformation of the thumbnail image is conducted, for example, as follows. FIG. 8B is a view showing a thumbnail image in the reference state. The thumbnail image in the reference state is in a rectangular shape having a length L in the vertical direction and a length S in the horizontal direction. The thumbnail image in the reference state has a side in the vertical direction that is in parallel with the vertical direction of the display region, and a side in the horizontal direction that is in parallel with the horizontal direction of the display region. The control section 3 adds to the thumbnail image in the reference state a transformation in the vertical direction while maintaining the width in the horizontal direction, thereby shifting the right side by S • sin θ • tan φ with respect to the left side (FIG. 8C)). Then, the control section 3 reduces the thumbnail image in the horizontal direction by a scaling factor of cos φ (FIG. 8D). Finally, the control section 3 reduces the thumbnail image in the vertical direction by a scaling factor of cos φ (FIG. 8E). The thumbnail image after transformation is in a parallelogram with the height being L • cos φ, and the width being S • cos θ, and the right side and the left side thereof are mutually shifted by S • sin θ • sin φ. The control section 3 stores the transformed thumbnail image in the RAM 5.

Referring back to FIG. 7, in step S130, the control section 3 generates a thumbnail image group. The thumbnail image group is an image of a plurality of thumbnail images composed together. In the thumbnail image group, the plurality of thumbnail images are in a state in which at least two thumbnail images among the plurality of thumbnail images are partially overlapped each other. In this example, the plural thumbnail images are arranged in a manner that their lower edges sit on one horizontal linear line. The plural thumbnail images are arranged in the order of their page numbers, for example, in a manner that the right end corresponds to the 1^{st} page, and the left end corresponds to the last page. Here, the interval between the thumbnail image at the p^{-th} page and the thumbnail image at the (p+1)^{-th} page is expressed as d (p). For example, d(SP1) expresses the interval between the thumbnail image of the first selected page and the thumbnail image of the next page. The interval d (p) is decided according to the parameter SP1.

FIG. 9 is a view showing an example of the interval d (p). In this example, the interval d (p) satisfies the following conditions. FIG. 9 shows, as an example, d (10) and d (11).

(1) In a certain range with the first selected page as a reference, the interval between the first selected page and the next page is at the maximum. For example, when the first selected page and its preceding k pages and the next page to the first selected page and its succeeding k pages are in this range, d (SP1) is at the maximum in the range of (SP1−k+1)≦p≦(SP1+k).

(2) In the range of (1), the interval d (p) becomes narrower (or equal) as pages are placed farther from the first selected page. In other words, in the range of (SP1−k+1)≦p≦SP1, d (SP1)≦d (p) is established, and in the range of (SP1+1)≦p≦(SP1+k), d (p+1)≦d (p) is established.

(3) When the range of (1) is exceeded, the interval d (p) becomes constant. More specifically, in the range of p<(SP1−k+1) and in the range (SP1+k)<p, d (p) is constant.

(4) The interval outside the boundary of the range of (1) is less than the interval within the boundary. More specifically, d (SP1−k)≦d (SP1−k+1) is established, and d (SP1+k)≦d (SP1+k+1) is established.

When the interval d is decided, the plural thumbnail images are composed. Composition of the thumbnail images is performed according to the following conditions.

(1) The first selected page and its preceding pages are arranged in a manner that higher page numbers are superposed on lower page numbers (Example: the 9^{th} page is superposed on the 8^{th} page, and 10^{th} page is superposed on the 9^{th} page).

(2) The page next to the first selected page and its succeeding pages are arranged in a manner that higher page numbers are superposed below lower page numbers (Example: the 12^{th} page is superposed below the 11^{th} page, and the 13^{th} page is superposed below the 12^{th} page).

In other words, in the thumbnail image group, the multiple thumbnail images are composed in a manner that the thumbnail image of the first selected page is positioned at the foremost surface.

FIG. 9 shows an example in which SP1=10 and k=10. The interval between the 10^{th} page and the 11^{th} page is at the maximum. In the range of 10 pages before and after that, respectively, the interval gradually becomes narrower. When this range is exceeded, the interval is constant.

In step S140, the control section 3 generates a display image. The display image includes an image of the first selected page and the thumbnail image group. The image of the first selected page is a large image that is not reduced in size. Specifically, the display image is an image in which the thumbnail image group is superposed on the image of the first selected page. In step S150, the control section 3 renders the display section 1 to display the display image. More specifically, the control section 3 writes data of the display image to the VRAM 4. Further, the control section 3 instructs the controller 2 to rewrite an image on the display section 1. The controller 2 controls the display section 1 to rewrite the image (details thereof will be discussed later).

In summary, the thumbnail image display process includes the step of receiving a selection of a first selected page from among the plurality of pages (step S100), and the step of updating a thumbnail image group displayed on the display section 1 when the selection is received (step S150). Here, the interval between the thumbnail image of the first selected page and the thumbnail image of a page before or after the first selected page in the thumbnail image group after the update is wider than the interval between the thumbnail image of the first selected page and the thumbnail image of a page before or after the first selected page in the thumbnail image group before the update.

FIG. 10 is a view showing an example of the display image. Here, the figure shows an example in which the 10^{th} page is selected, in other words, SP1=10. In FIG. 10, characters appearing on each of the pages in the display image are presented by dots “•” to avoid complication of the drawing. In this example, a thumbnail image group SI is displayed in a manner superposed on a lower section of an image P of the first selected page. In the display screen, the area of the thumbnail image group is smaller than the area of the first selected page. According to this example, the user can confirm the content of the first selected page by the large image, and further can confirm as to where the first selected page is located in the entire electronic book by the thumbnail image group.

### 2-2. PAGE UPDATE

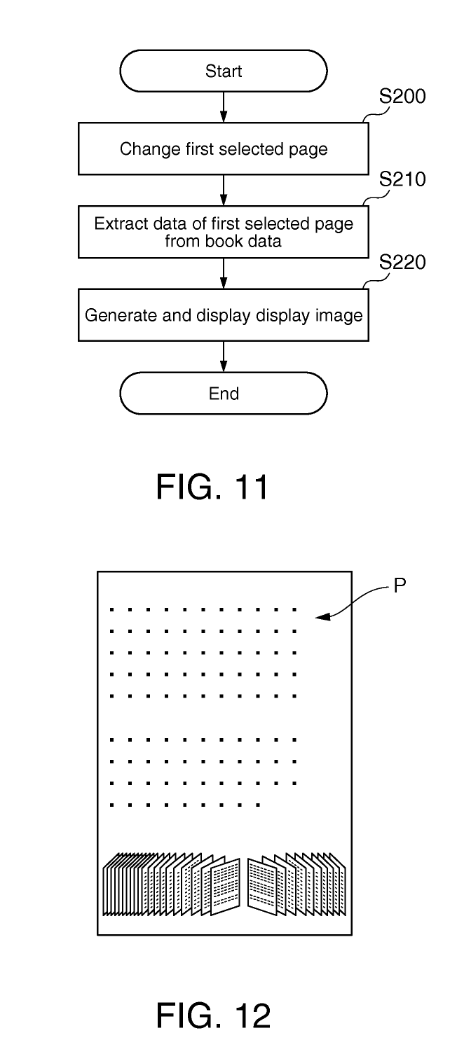

FIG. 11 is a flow chart showing a page display update process. The “page display update” is a process of updating the first selected page, when an operation to turn forward or back pages in the electronic book is performed. The processing flow in FIG. 11 is executed in a state in which the display image shown in FIG. 10 is displayed.

In step S200, the control section 3 changes the value of the parameter SP1 that specifies the first selected page. The parameter SP1 is stored in the RAM 5, and is rewritten by the control section 3. The value of the parameter SP1 is changed according to an instruction inputted by the user. For example, when an operation to turn forward the page of the electronic book (for example, when the button 9F is depressed), the control section 3 adds 1 to the value of the parameter SP1. When an operation to turn back the page of the electronic book (for example, when the button 9E is depressed), the control section 3 subtracts 1 from the value of the parameter SP1.

In step S210, the control section 3 extracts data of the first selected page specified by the updated parameter SP1 from the book data. In step S220, the control section 3 generates and displays a display image using the data of the first selected page. The processes of generating and displaying the display image are executed in a manner described in conjunction with FIG. 7.

FIG. 12 is a view showing an example of a display image of the pages that have been turned forward by five pages from the state shown in FIG. 10. More specifically, FIG. 12 shows a case where SP1=15. The thumbnail image group also changes, accompanying the change of the first selected page. Therefore, the user can readily recognize what page is selected in the book.

### 2-3. SEARCH

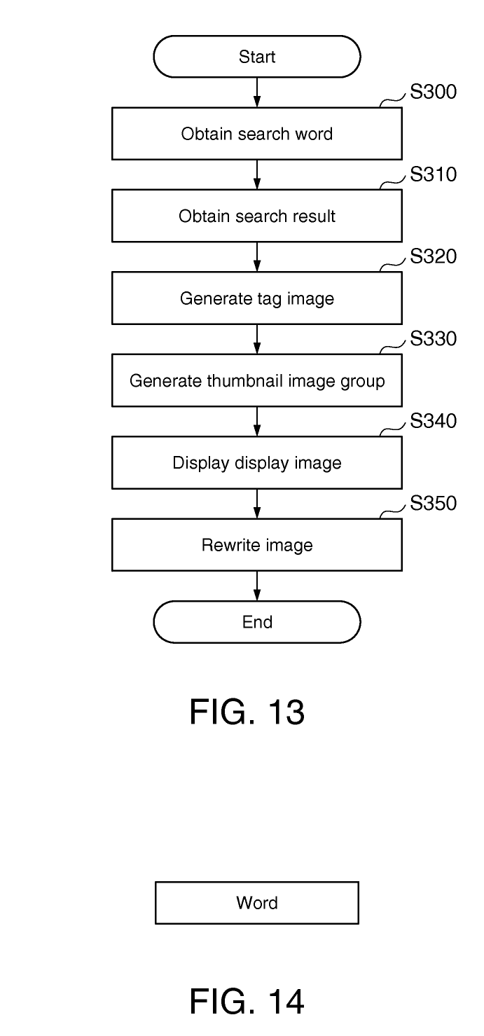

FIG. 13 is a flow chart showing a process of searching in the electronic book. The processing flow shown in FIG. 13 is started with a user's input of a predetermined event as a trigger, for example, an instruction to start a search. Here, an example in which a specified word is searched from among the electronic book is described. In step S300, the control section obtains a search word. The search word is inputted by the user through operating the operation section 9. The control section 3 stores the search word obtained in the RAM 5.

In step S310, the control section 3 obtains a search result. In this example, the search may be conducted by using a search engine (a search program). As the search engine, any known search engine may be used. The control section 3 calls and instructs the search engine to search a search word. The search engine stores the search result in the RAM 5. The search result includes information that specifies the position of the search word in the electronic book, for example, a set of an identification number Ri, a page number Rp, a row number RI, and a character number Rc. This set indicates that the search word exists at the page Rp and the row RI with the character Rc.

In step S320, the control section 3 generates a tag image. The “tag image” is an image having a shape that is distinguishable from the thumbnail image and the page image. In this example, the area of a tag image is smaller than that of the thumbnail image.

FIG. 14 is a view showing an example of the tag image. In this example, the tag image has a rectangular shape. The rectangular shape, in other words, the length of the vertical side and the length of the horizontal side of the tag image is decided. Also, a search word (“word” in this example) is shown inside the rectangular shape. The state of the rectangular shape viewed in a plan view in a manner described above is referred to as a “standard state.” In the present embodiment, the tag image is transformed in a similar manner as the thumbnail image. The process of “generating” a tag image in step S320 includes a process of transforming a tag image to be described below.

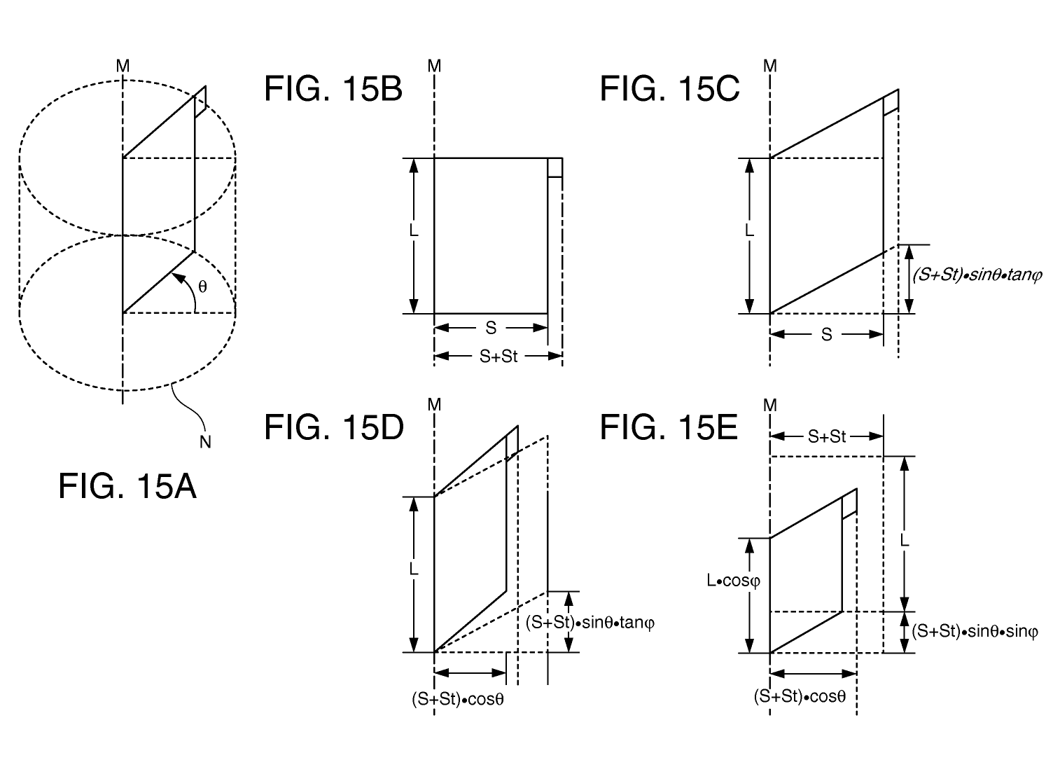

FIGS. 15A-15E are views for describing the process of transforming a tag image. Tag images are generated corresponding to thumbnail images of pages where the search word is present. For example, when the search word is present in the 2^{nd} page and the 5^{th} page, the tag image is generated for each of the 2^{nd} page and the 5^{th} page. In this example, even when the search words are present in plurality in a single page, a single tag image is generated for a single thumbnail image. For example, even when the search word appears five times in the 2^{nd} page, a single tag image is generated for the 2^{nd} page.

Transformation of a tag image is performed in the same manner as transformation of a corresponding thumbnail image. FIG. 15A is a view showing an example of a tag image after transformation. The tag image is attached to a predetermined position with respect to a corresponding thumbnail image. FIG. 15B is a view showing a tag image and a thumbnail image in the reference state. In this example, the tag image is added to the right side at the upper end of the thumbnail image. More specifically, the tag image is attached in a manner that the left upper apex of the tag image coincides with the right upper apex of the thumbnail image, and the tag image and the thumbnail image do not overlap each other. The tag image in the reference state has a length Lt in the vertical direction, and a length St in the horizontal direction. The thumbnail image in the reference state has a length L in the vertical direction, and a length S in the horizontal direction. An image that combines the tag image and the thumbnail image, as a whole, has a length L in the vertical direction and a length (S+St) in the horizontal direction. The control section 3 adds to, the tag image and the thumbnail image in the reference state, a transformation in the vertical direction while maintaining the width in the horizontal direction, thereby shifting the right side by (S+St) • sin θ • tan φ with respect to the left side (FIG. 15C)). Then, the control section 3 reduces the thumbnail image in the horizontal direction by a scaling factor of cos φ (FIG. 15D). Finally, the control section 3 reduces the thumbnail image in the vertical direction by a scaling factor of cos φ (FIG. 15E). The tag image and the thumbnail image after transformation are in a shape inscribed in a parallelogram with the height being L • cos φ, and the width being (S+St) • cos θ, and the right side and the left side of the parallelogram are mutually shifted by S • sin θ • sin φ. In other words, the tag image is transformed by using the same parameters as the parameters (the angle of rotation θ and the angle of depression φ) used for transformation of the corresponding thumbnail image. The control section 3 stores the transformed tag image in the RAM 5.

Referring back to FIG. 13, in step S330, the control section 3 generates a thumbnail image group. The “thumbnail image group” herein referred to include the tag image. The thumbnail image group including the tag image is generated in a manner similar to the thumbnail image group described above generated in step S130 (which does not include the tag image). In step S340, the control section 3 generates a display image. The display image includes an image of the first selected page and the thumbnail image group. In step S350, the control section 3 renders the display section 1 to display the display image.

In summary, the display control method in accordance with the present embodiment includes the steps of: obtaining a plurality of thumbnail images for a document having a plurality of pages, the thumbnail images each presenting each of the plurality of pages reduced in size in a reference state, rotated about a virtual rotation axis as a center, and processed into a view overlooked from a certain viewpoint (step S110); obtaining a first search subject (step S120); obtaining a first tag image corresponding to the first search subject obtained (step S320); and displaying a thumbnail image group on a display device, the thumbnail image group including the plurality of thumbnail images in a state in which at least two thumbnail images among the plurality of thumbnail images are partially overlapped each other and the first tag image is attached to a thumbnail image of a page including the first search subject (step S150). Also, the tag image is processed so as to be rotated from the reference state through the same angle of rotation as that of the corresponding thumbnail image about the rotation axis of the thumbnail image, and in a view overlooked from the viewpoint of the thumbnail image.

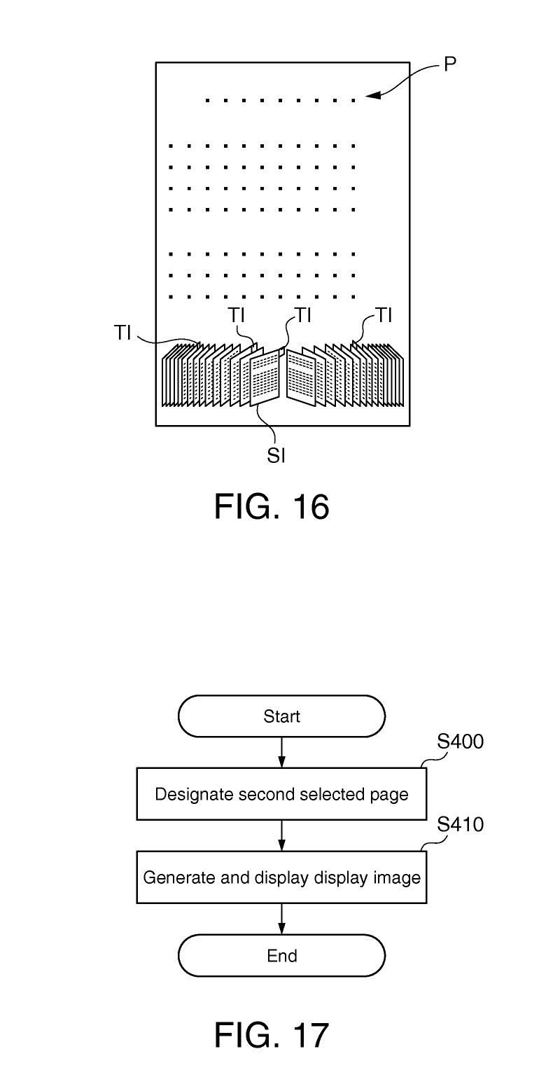

FIG. 16 is a view showing an example of a display image including tag images TI. According to this example, the user can confirm the positions of the pages that contain the search word with respect to the entire electronic book by the thumbnail image group SI.

### 2-4. DISPLAY OF SECOND SELECTED PAGE

According to the electronic apparatus 1000, in addition to the first selected page, another page can be selected. Hereafter, this page is referred to as the “second selected page.” The first selected page is a page that is primarily displayed on the display screen, and the second selected page is displayed in a manner that can be discriminated from other pages in the thumbnail image group.

FIG. 17 is a flow chart showing a process of displaying a thumbnail image group including the second selected page. The processing flow of FIG. 17 is started with a predetermined event as a trigger, such as, for example, a user's input of an instruction to designate a second selected page, in a state in which the first selected page and the thumbnail image group are displayed. In step S400, the control section 3 changes the value of a parameter P2 that specifies the second selected page. The value of the parameter P2 is changed in response to an operation of the operation section 9 by the user. For example, when the operation section 9 includes a touch screen provided on the display section 1, the user may touch a portion where a page desired to be selected among the thumbnail image group is displayed, thereby designating the second selected page. Alternatively, the user may operate the buttons 9A-9F to designate the second selected page.

In step S410, the control section 3 generates and displays a display image. The process of generating and displaying the display image is performed basically in a similar manner as described in Section 2-1 above. However, the description in Section 2-1 refers to a case where the parameter P2 has “no value,” in other words, no second selected page is present. When the parameter P2 has a value, generation of a thumbnail image group in step S130 is conducted in consideration of the parameter P2. More specifically, an interval d (p) between two adjacent thumbnail images is decided according to the parameter P2. Concretely, the following conditions (5)-(7) are used, in addition to the conditions (1)-(4) described above with respect to the interval d (p).

(5) The interval between the second selected page and a preceding page or a succeeding page is wider than the interval when that page was not selected as the second selected page.

(6) The interval between the second selected page and a preceding page or a succeeding page is wider than its surrounding portion. In other words, d (P2)>d (P2+1) and d (P2−2)<d (P2−1) are established.

(7) The interval between the second selected page and a preceding page is equal to the interval between the second selected page and a succeeding page. In other words, d (P2−1)=d (P2) is established.

In summary, the process of displaying the second selected page includes the steps of receiving a selection of a second selected page from among the plurality of pages (step S400), and updating the thumbnail image group displayed on the display device 1 upon receiving the selection (step S410). Here, the interval between a thumbnail image of the second selected page and a thumbnail image of a page before or after the second selected page in the thumbnail image group after update may be wider than the interval between a thumbnail image of the second selected page and a thumbnail image of a page before or after the second selected page in the thumbnail image group before update.

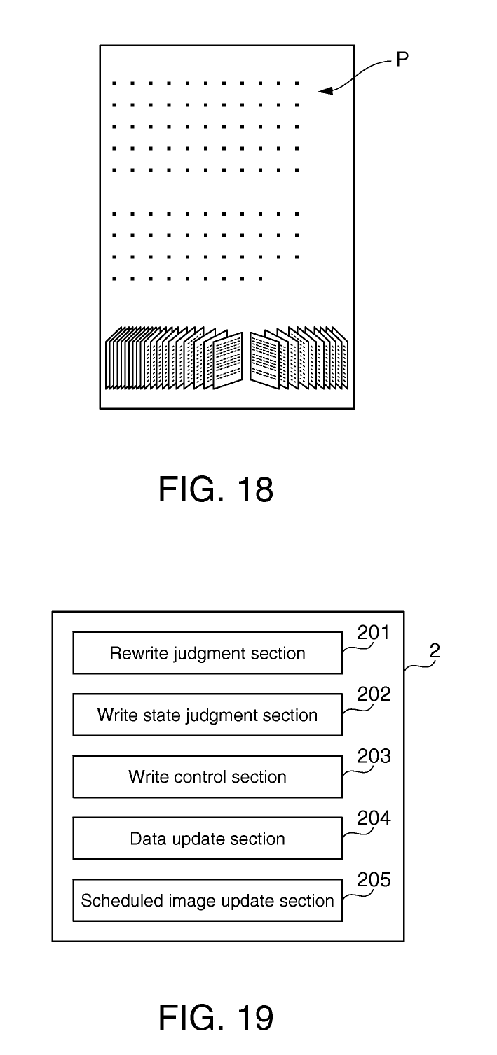

FIG. 18 is a view showing an example of a thumbnail image group that includes the second selected page. In the example shown here, SP1=15, P2=21 and k=10. According to this example, when the second selected page is designated (changed), the interval between the second selected page and a page before or after the second selected page becomes wider, compared to the interval before the second selected page is designated. Furthermore, the interval between the second selected page and a page before or after the second selected page is wider than the interval in its surrounding area. Therefore, the user can see the content of a page other than the first selected page, while reading the first selected page. Also, a search may be conducted after selection of the second selected page, and then a thumbnail image group with tag images may be displayed.

### 2-5. REWRITING OF DISPLAY

Next, the process of rewriting an image in step S150 and S350 will be described in detail. In the electronic apparatus 1000, the display state of pixels from white (a lower density or a lower gradation level) to black (a higher density or a higher gradation level) or black to white changes by application of voltages (accumulation of charges) across a plurality of frames. In other words, application of voltages in a single frame does not change the pixels to a desired display state.

FIG. 19 is a block diagram showing a functional configuration of the controller 2. The controller 2 includes a rewrite judgment section 201, a write state judgment section 202, a write control section 203, a data update section 204, and a scheduled image update section 205. These functions may be realized by hardware. In another example, the controller 2 may be provided with a processor, and the processor may execute a program to realize each of the functional blocks.

The rewrite judgment section 201 compares image data stored in the VRAM 4 with image data stored in the scheduled image data memory region 7, and judges as to whether or not they are different from each other. The write state judgment section 202 refers to data stored in the write data memory region 6, and judges as to whether or not a rewrite operation to change the pixels from black to white or white to black is in progress. The write data memory region 6 includes a white write data memory region 6A that stores data, for each of the pixels, indicative of whether or not an operation of changing the display state of the pixel from black to white is in progress (first write data), and a black write data memory region 6B that stores data, for each of the pixels, indicative of whether or not an operation of changing the display state of the pixel from white to black is in progress (second write data).

The write control section 203 controls the scanning line drive circuit 53 and the data line drive circuit 54 so as to supply data signals to the pixel electrodes 13a of desired pixels. The data update section 304 writes data to the white write data memory section 6A and the black write data memory section 6B. The scheduled image update section 205 overwrites image data stored in the schedule image data memory region 7 with image data stored in the VRAM 4.

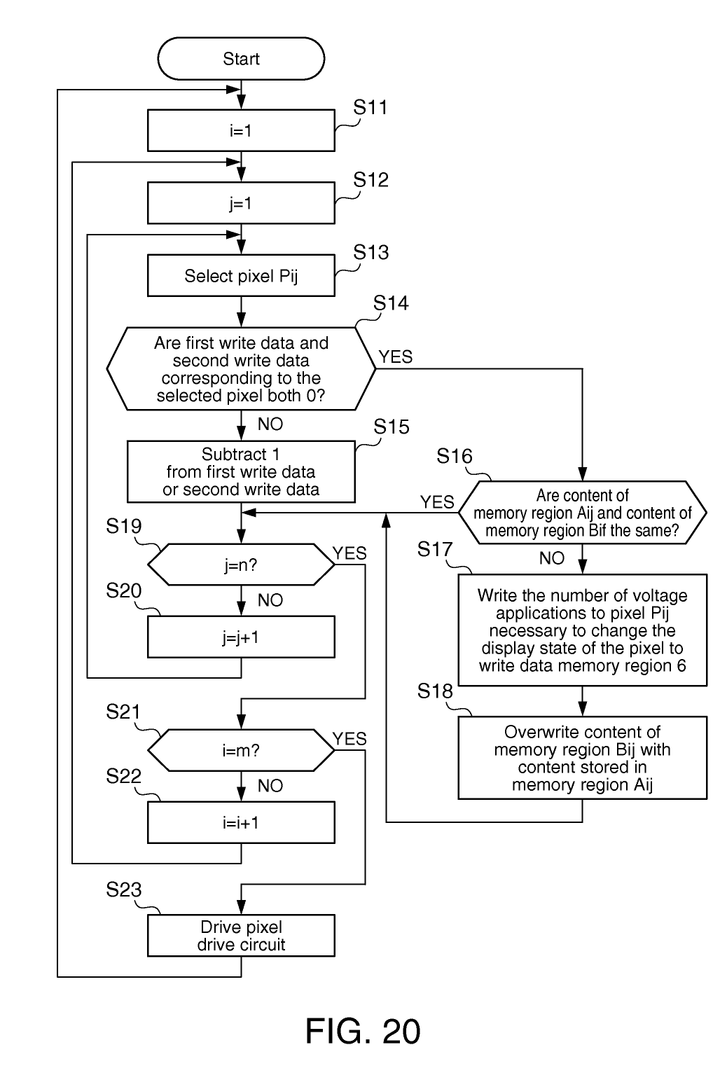

FIG. 20 is a flow chart showing a process of driving the display section 1 by the controller 2. In the following description, a pixel at the i^{-th} row and j^{-th} column in the display section 1 is referred to as a pixel Pij. A region in the VRAM 4 that stores data indicative of the gradation of the pixel Pij is a memory region Aij. In this example, data stored in the memory region Aij are binary values, 0 (black) or 7 (white). A region in the scheduled image data memory region 7 that stores scheduled image data of the pixel Pij is a memory region Bij. The scheduled image data is data indicative of the state of the display section 1 at the time of completion of the write processing in progress. In this example, data stored in the memory region Bij are binary values, 0 (black) or 7 (white). The write data memory region 6 includes the white write data memory region 6A and the black write data memory region 6B. The white write data memory region 6A stores the number of remaining voltage applications at each pixel necessary to turn the gradation from black to white as first write data. The black write data memory region 6B stores the number of remaining voltage applications at each pixel necessary to turn the gradation from white to black as second write data. A memory region Cij is a region in the white write data memory region 6A to store data indicative of the number of remaining voltage applications at the pixel Pij. A memory region Dij is a region in the black write data memory region 6B to store data indicative of the number of remaining voltage applications at the pixel Pij.

In step S11 and S12, the write state judgment section 202 initializes values of the variables i and j. In this example, the variables i and j are initialized to 1 (i=1 and j=1). In step S13, the write state judgment section 202 selects a pixel Pij specified by the variables i and j. For example, when the value of the variable i is 1, and the value of the variable j is 1, a pixel P11 is selected.

In step S14, the write state judgment section 202 judges as to whether both of the first write data stored in the memory region Cij and the second write data stored in the memory region Dij are 0. The write state judgment section 202 judges as to whether the write processing for the pixel Pij is not continued. When both of the first write data and the second write data corresponding to the pixel Pij are 0 (step S14: YES), the write state judgment section 202 shifts the processing to step S16. When one of the first write data and the second write data corresponding to the pixel Pij is not 0 (step S14: NO), the controller 2 shifts the processing to step S15.

In step S15, the data update section 204 deducts 1 from the first write data or the second write data whose value is other than 0. It is noted that data update section 204 does not deduct 1 for the first write data or the second write data whose value is 0. In step S19, the data update section 204 judges as to whether or not the value of the variable j is the same as the number n of the data lines. If the value of the variable j is not n (step S19: NO), the data update section 204 adds 1 to the value of the variable j (step S20). After adding 1 to the value of the variable j, the data update section 204 shifts the processing to step S13. When the value of the variable j is n (step S19: YES), the data update section 204 shifts the processing to step S21. In step S21, the data update section 204 judges as to whether or not the value of the variable i is the same as the number m of the scanning lines. If the value of the variable i is not m (step S21: NO), the data update section 204 adds 1 to the value of the variable i (step S22). After adding 1 to the value of the variable i, the data update section 204 shifts the processing to step S12. When the value of the variable i is m (step S21: YES), the data update section 204 shifts the processing to step S23. In step S23, the write control section 203 controls the scanning line drive circuit 53 and the data line drive circuit 54 to drive the pixel drive circuit.

In step S16 (judgment step), the rewrite judgment section 201 judges as to whether the data stored in the memory region Aij is the same as the data stored in the memory region Bij. If the data are different (step S16: NO), the rewrite judgment section 201 shifts the processing to step S17.

In step S17 (data update step), the data update section 204 writes, to the write data memory region 6, the number of voltage applications to the pixel Pij necessary to change the gradation of the pixel Pij to the gradation of the memory region Aij. In step S18, the scheduled image update section 205 overwrites the content of the memory region Bij with the content stored in the memory region Aij.

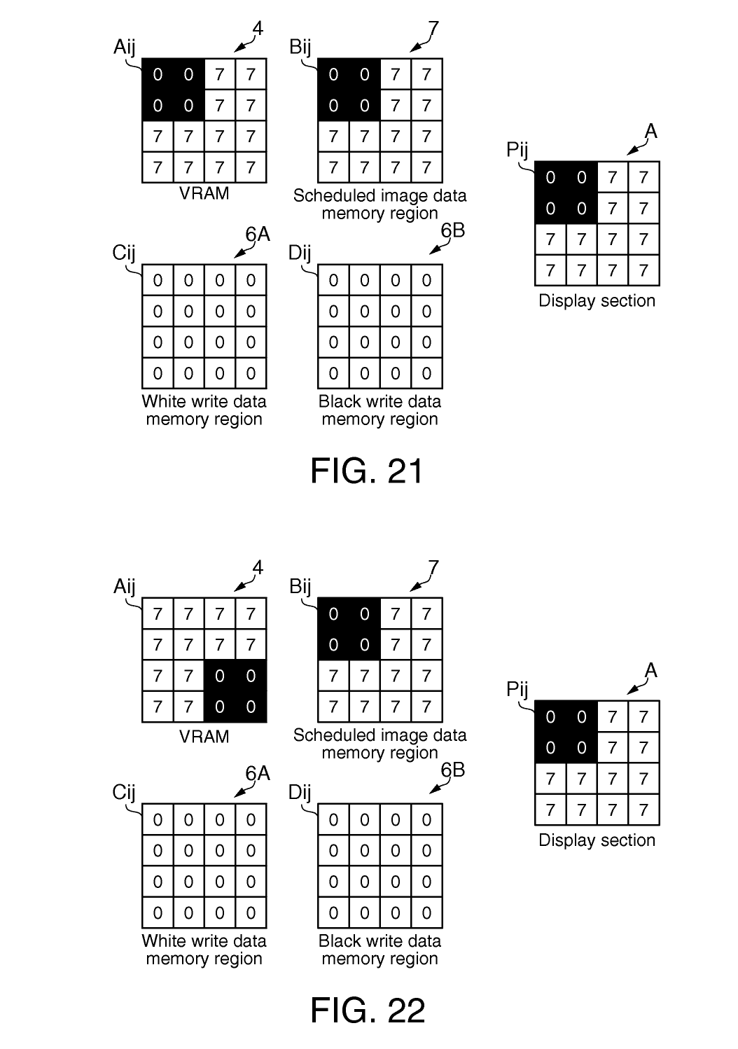

FIG. 21 shows diagrams exemplifying data stored in the memories. Here, the operation is described, using pixels P11-P44 in an array of four rows by four columns which form a part of the display section 1, as an example. In this example, the gradation of each of the pixels is presented in 8 levels between 0 and 7. The gradation level 7 corresponds to white, and the gradation level 0 corresponds to black. To facilitate understanding of the figure, numerical values are described at the pixels, but these numbers are not displayed. In the example of FIG. 21, the pixels P11, P12, P21 and P22 are black, and other pixels are white. The figure shows a state in which none of the pixels is in progress of writing, and writing has been completed for the entire pixels.

FIG. 22 shows diagrams exemplifying a state in which the VRAM 4 is rewritten. In this example, the pixels P33, P34, P43 and P44 are black, and other pixels are white. Rewriting of the VRAM 4, in other words, writing data to the VRAM 4 (data writing step) is executed by the control section 3. Now, the operation is described using an example in which the pixel P11 is selected in step S13 the state shown in FIG. 22. In this case, as data stored in the memory regions C11 and D11 are both 0, the judgment result in step S14 is YES. Next, as the data in the memory region A11 and the memory region B11 are not the same, the judgment result in step S16 is NO. In step S17, the data of the memory region B11 is written to the memory region C11. In step S18, the data of the memory region A11 is written to the memory region B11.

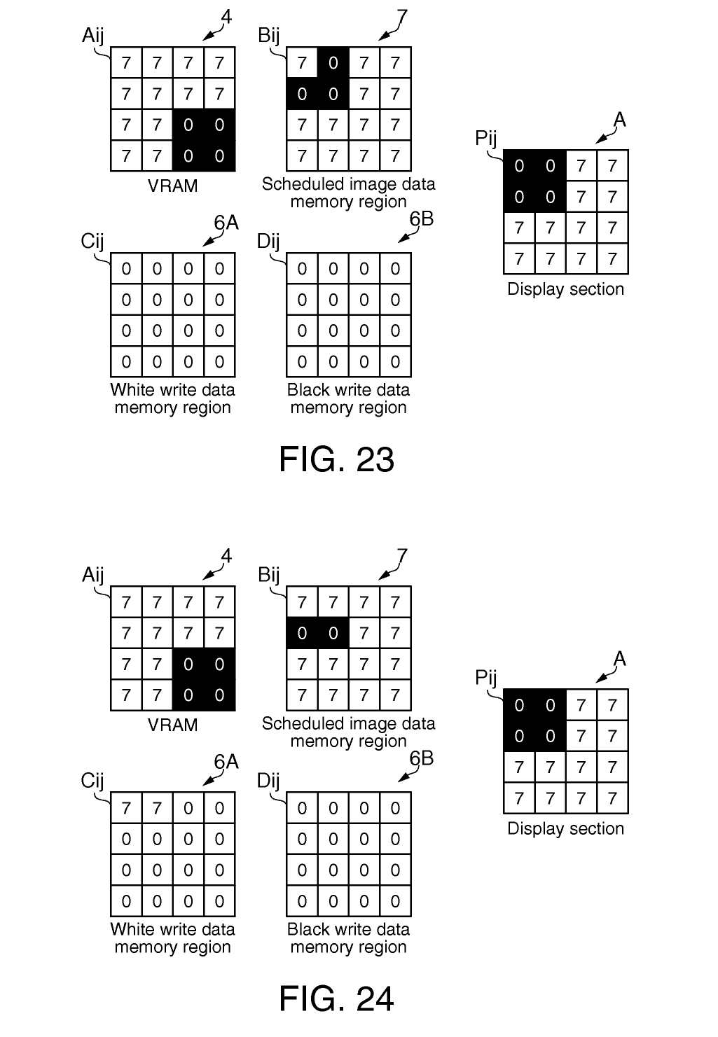

FIG. 23 shows diagrams exemplifying a state in which the data in the memory region B11 is rewritten. Next, the target pixel is updated to the pixel P12. As the data stored in the memory regions C12 and D12 are both 0, the judgment result in step S14 is YES. Next, as the data of the memory region A12 and the data of the memory region B12 are not the same, the judgment result in step S16 is NO. In step S17, data indicative of the number of voltage applications (7 times in this example) is written to the memory region C12. In step S18, the data of the memory region A12 is written to the memory region B12.

FIG. 24 shows diagrams exemplifying a state in which the data in the memory region B12 has been rewritten. Similarly, when the processing advances up to the pixel P44, the data stored in the scheduled image data memory region 7 becomes equal to the data stored in the VRAM 4.

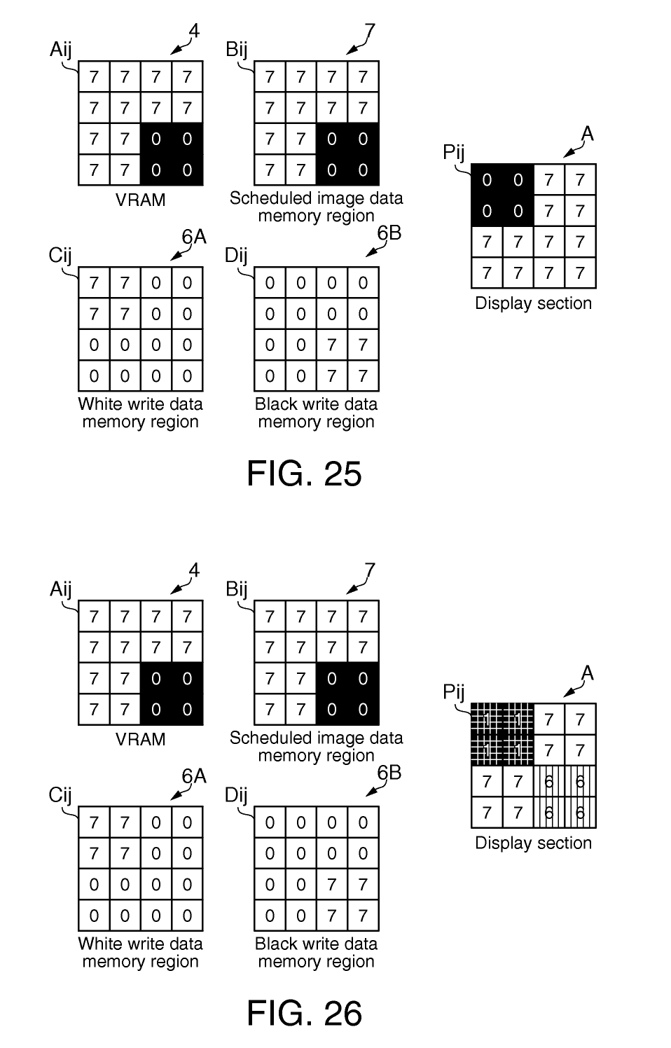

FIG. 25 shows diagrams exemplifying a state in which data for the entire pixels have been rewritten. For those of the pixels whose gradation is to be changed from black to white, the data stored in the corresponding memory regions Cij (C11, C12, C21 and C22) are “7.” For those of the pixels whose gradation is to be changed from white to black, the data stored in the corresponding memory regions Dij (D33, D34, D43 and D44) are “7.” In the memory regions Cij and Dij, the data of the other pixels are “0.”

When the data rewriting is completed, the write control section 203 drives the display section 1. When the scanning line in the i^{-th} row is selected, for those of the pixels whose corresponding data in the memory regions Cij are other than 0, the write control section 203 performs a voltage application control such that the potential on the pixel electrodes 13a becomes lower with the potential Vcom on the transparent electrode 32 as a reference. For those of the pixels whose corresponding data in the memory regions Dij are other than 0, the write control section 203 performs a voltage application control such that the potential on the pixel electrodes 13a (a potential difference between the pixel electrode 13a and the transparent electrode 32 is hereafter simply called a “pixel voltage” with the potential Vcom on the transparent electrode 32 as a reference) becomes higher with the potential Vcom on the transparent electrode 32 as a reference. For example, for the pixel P11, the data stored in the memory region C11 is not 0. Therefore, when the scanning line in the 1^{st} row is selected, a voltage for setting the voltage on the pixel to −15V is applied to the data line in the 1^{st} column. In another example, for the pixel P33, the data stored in the memory region D33 is not 0. Therefore, when the scanning line in the 3^{rd} row is selected, a voltage for setting the voltage on the pixel to +15V is applied to the data line in the 3^{rd} column. Further, for those of the pixels Pij whose data in the corresponding memory regions Cij and in the corresponding memory regions Dij are both 0, a voltage for setting the voltage on the pixels to 0V is applied to the data line in the j^{-th} column.

FIG. 26 shows diagrams exemplifying a state in which voltage applications have been conducted for one frame from the state shown in FIG. 25. At the pixels in the display section 1, their gradation has changed due to migration of the charged particles. In this example, the pixels P11, P12, P21 and P22 have become lighter from black to a gradation level achieved by the voltage applications for one frame, and the pixels P33, P34, P43 and P44 have become darker from white to a gradation level achieved by the voltage applications for one frame.

When the voltage applications for one frame are completed, the process by the controller 2 is repeated from step S11 again. When the pixel P11 is selected in step S13 in the state shown in FIG. 26, the data stored in the memory region C11 is not 0, such that the judgment result in step S14 is NO. In step S15, 1 is subtracted from the data (data other than 0) stored in the memory region C11, such that the data in the memory region C11 becomes 6. In a similar manner described above, data in the memory regions for the entire pixels are rewritten.

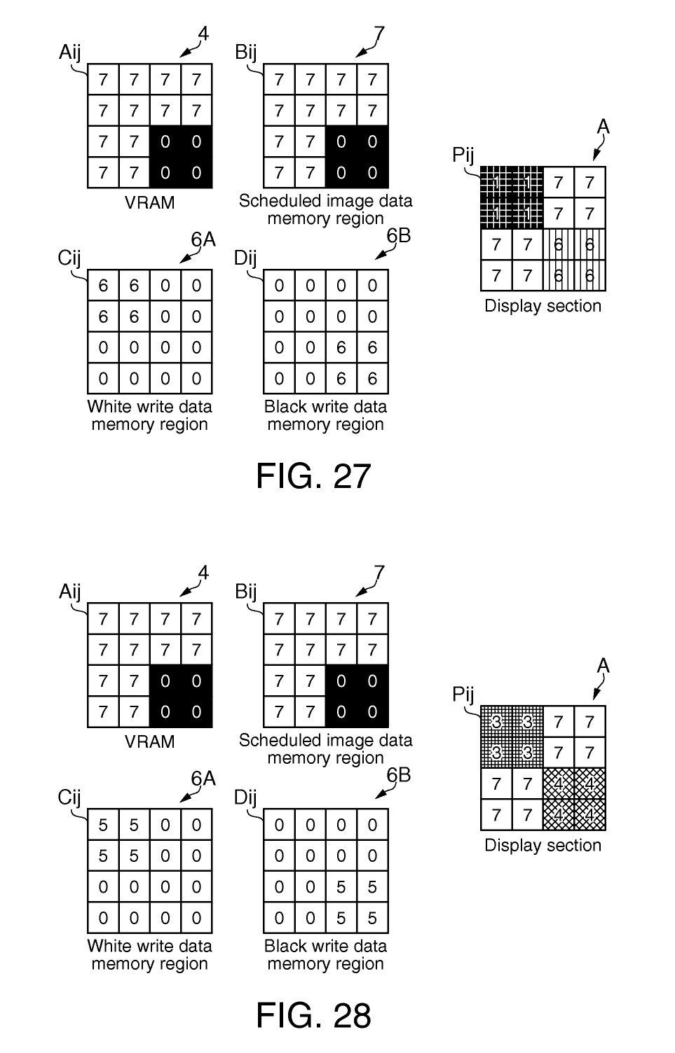

FIG. 27 shows diagrams exemplifying a state in which rewriting of data in the write data memory region for the entire pixels has been completed. In comparison with the state shown in FIG. 26, the state in FIG. 27 is different in that the data in the memory regions C11, C12, C21 and C22, and the data in the memory regions D33, D34, D43 and D44 have changed to six.

FIG. 28 shows a state immediately after the processing in step S23 has been executed for the second time since the state shown in FIG. 27. Compared to the state shown in FIG. 27, the state in FIG. 28 is different in that the data in the memory regions C11, C12, C21 and C22, and the data in the memory regions D33, D34, D43 and D44 have changed to five. Further, the state in FIG. 28 is different from the state in FIG. 27 in that the gradation at the pixels P11, P12, P21 and P22 in the display section 1 has changed to three, and the gradation at the pixels P33, P34, P43 and P44 has changed to four. Here, let us consider operations when data in the VRAM 4 is rewritten in the state shown in FIG. 28 (immediately after the processing in step S23 has been executed for the second time).

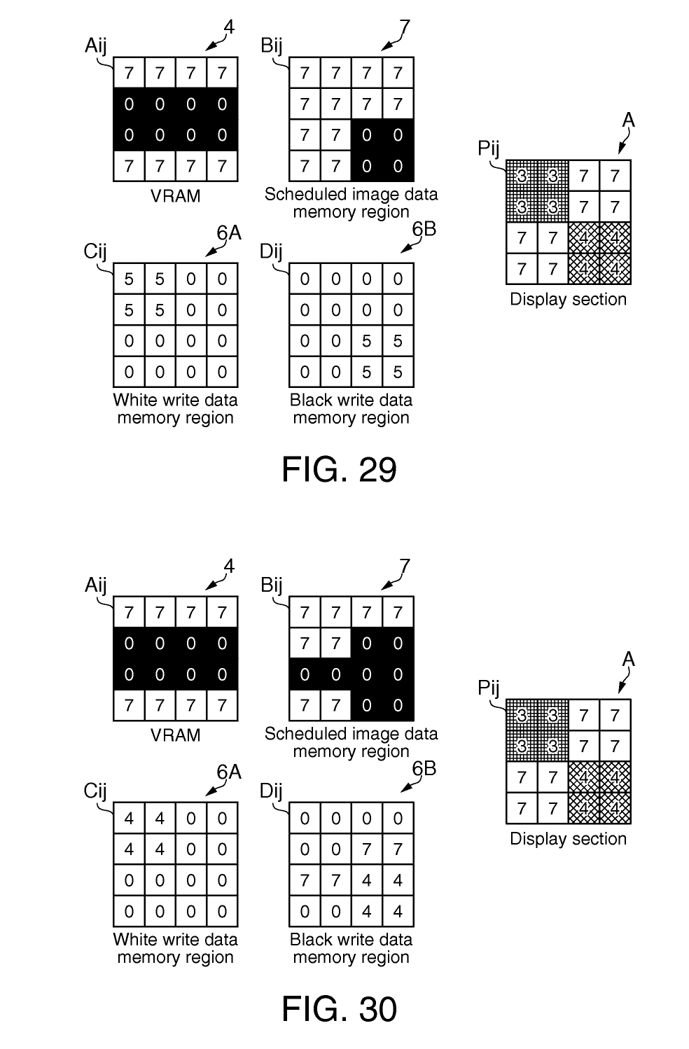

FIG. 29 shows diagrams exemplifying a state in which data in the VRAM 4 are rewritten. In this example, all of the pixels in the 1^{st} row and the 4^{th} row are white, and all of the pixels in the 2^{nd} row and the 3^{rd} row are black. In this state, the controller 2 executes the processings from step S11. For example, when the pixel P21 is selected in step S13, the judgment result in step S14 is NO. In step S15, 1 is subtracted from the data in the memory region C21 and it becomes 4. In another example, when the pixel P23 is selected in step S13, the judgment result in step S14 is YES. Further, the judgment result in step S16 is NO. Therefore, the process proceeds to step S17. In step S17, “7” is written as data in the memory region D23. In step S18, the data in the memory region A23 is written to the memory region B23. In this manner, even when data in the VRAM 4 are rewritten, for those of the pixels in progress of rewriting (for example, the pixels P11, P12, P21, P22, P33, P34, P43 and P44 in the example of FIG. 29), the rewriting process in progress (the process of rewriting pixels based on the data of the VRAM 4 prior to rewriting) is continued. On the other hand, for those of the pixels not in progress of rewriting (for example, the pixels P13, P14, P23, P24, P31, P32, P41 and P42), the pixel rewriting process is conducted based on the rewritten data of the VRAM 4.

FIG. 30 shows diagrams exemplifying a state in which data rewriting process for the entire pixels has been completed since the state shown in FIG. 29. Comparing to the state shown in FIG. 29, the state in FIG. 30 is different in that the data in the memory regions B23, B24, B31 and B32 have been rewritten to 0, the data in the memory regions C11, C12, C21, C22, D33, D34, D43 and D44 have been rewritten to 4, and the data in the memory regions D23, D24, D31 and D32 have been rewritten to 7.

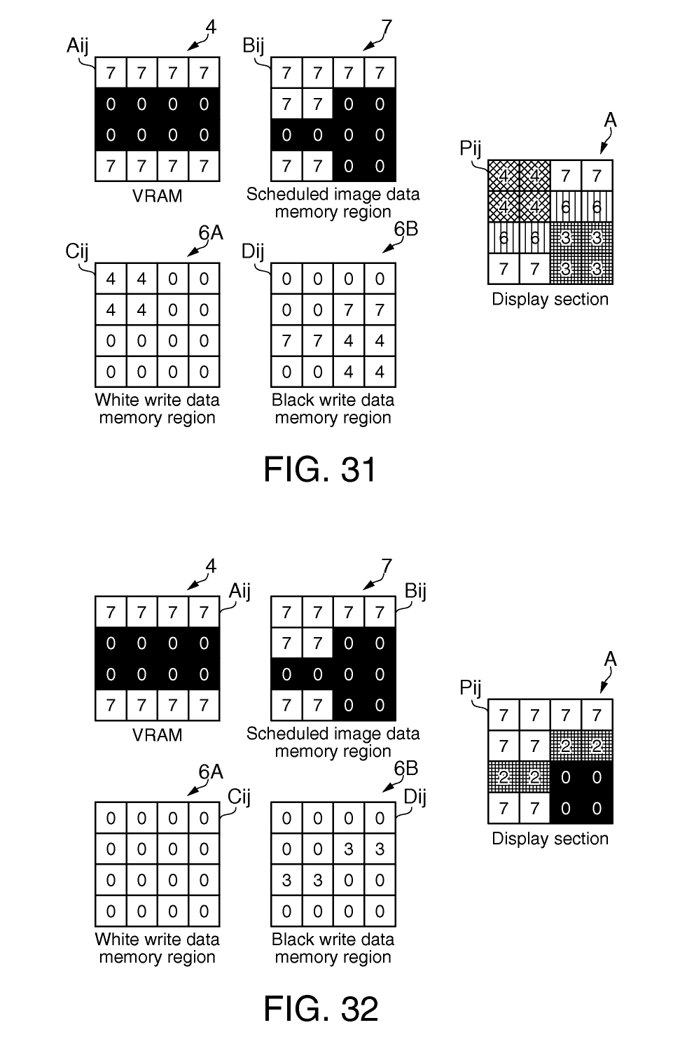

FIG. 31 shows diagrams exemplifying a state in which the processing in step S23 has been conducted since the state shown in FIG. 30. For those of the pixels that have already been in progress of rewriting prior to the data rewriting occurred in the VRAM 4 (the pixels P11, P12, P21, P22, P33, P34, P43 and P44), the ongoing rewriting process is continued irrespective of the data of the VRAM 4 after the rewriting has taken place. Among pixels that have become necessary to be rewritten after the data rewriting occurred in the VRAM 4, for those of the pixels that were not in progress of rewriting prior to the data rewriting in the VRAM 4 (the pixels P13, P14, P31 and P32), rewriting of the pixels is started based on the data of the VRAM 4 after the rewriting.

FIG. 32 shows diagrams exemplifying a state in which the rewriting process has been further advanced from the state shown in FIG. 31, where voltage applications in a predetermined number of times have been completed for those of the pixels that were already in progress of rewriting prior to the data rewriting occurred in the VRAM 4 (the pixels P11, P12, P21, P22, P33, P34, P43 and P44). In this state, in the write data memory region 6, the data in the memory region D23, D24, D31 and D32 are 3, and the data in other memory regions are 0. In the display section 1, the gradation level at the pixels P23, P24, P31 and P32 is 2; the gradation level at the pixels P33, P34, P43 and P44 is 0; and the gradation level at the other pixels is 7. For example, if the pixel P21 is selected in step S13 in this state, the judgment result in step S14 is YES. Further, the judgment result in step S16 is NO. In step S17, “7” is written as data of the memory region D21. In step S18, “0” which is the same data as that of the memory region A21 is written to the memory region B21.

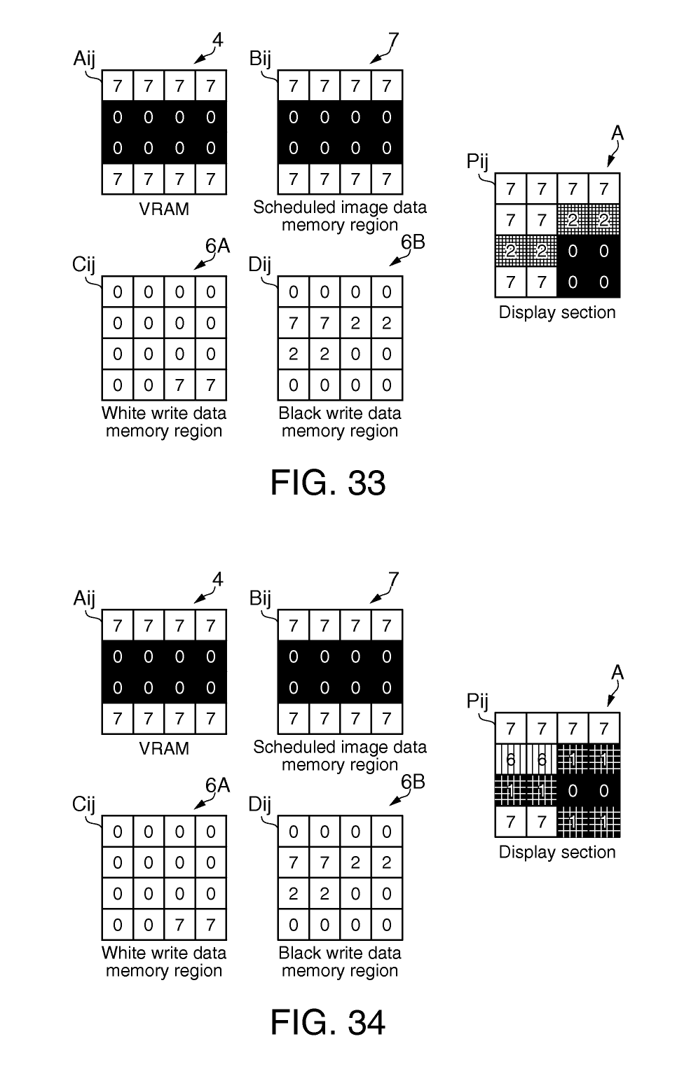

FIG. 33 shows diagrams exemplifying a state in which the data rewriting for the entire pixels has been completed. Comparing to the state shown in FIG. 33, the state shown in FIG. 33 is different in that the values in the memory regions B21 and B22 have become 0, and the data in the memory regions B43 and B44 have become 7; the data in the memory regions C43, C44, D21 and D22 have become 7; and the data in the memory regions D23, D24, D31 and D32 have become 2.

FIG. 34 shows diagrams exemplifying a state in which the pixels have been rewritten since the state shown in FIG. 33. Comparing to the state shown in FIG. 33, the state in FIG. 34 is different in that the gradation level of the pixels P23, P24, P31 and P32 has become 1; the gradation level of the pixels P21 and P22 has become 6; and the gradation level of the pixels P43 and P44 has become 1.

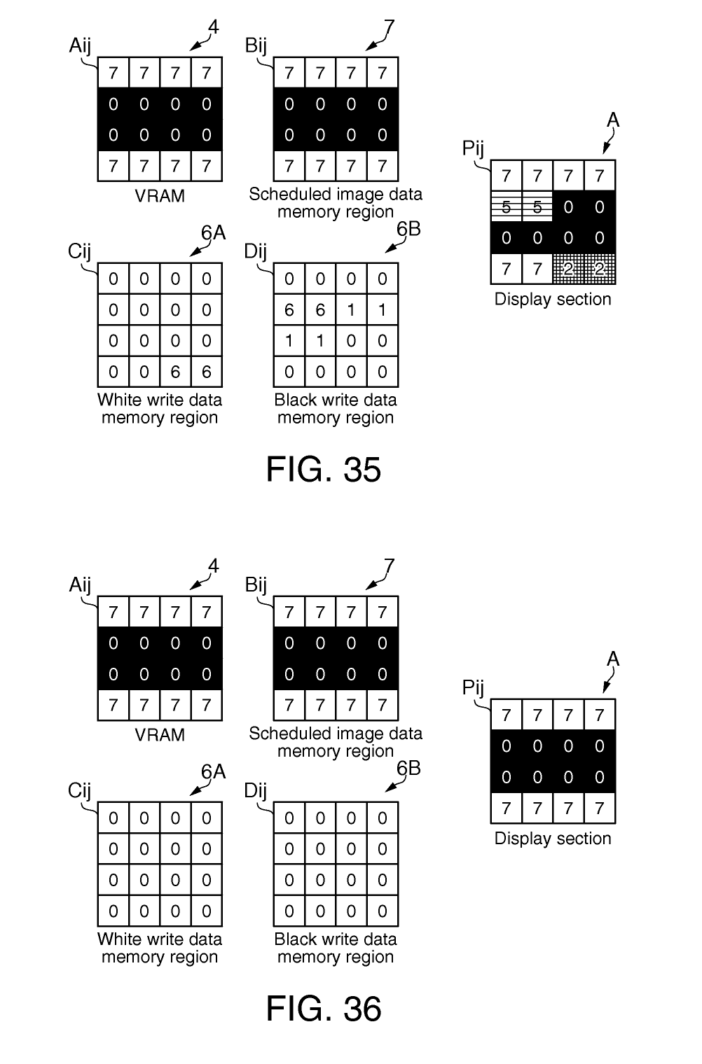

FIG. 35 shows diagrams exemplifying a state in which the process has advanced by one frame from the state shown in FIG. 34. Comparing to the state shown in FIG. 34, the state in FIG. 35 is different in that the gradation of the pixels P23, P24, P31 and P32 has become 0; the gradation of the pixels P21 and P22 has become 5; and the gradation of the pixels P43 and P44 has become 2. Further, the state shown in FIG. 35 is different in that the data in the memory regions C43, C44, D21 and D22 have become 6; and the data in the memory regions D23, D24, D31 and D32 have become 1.

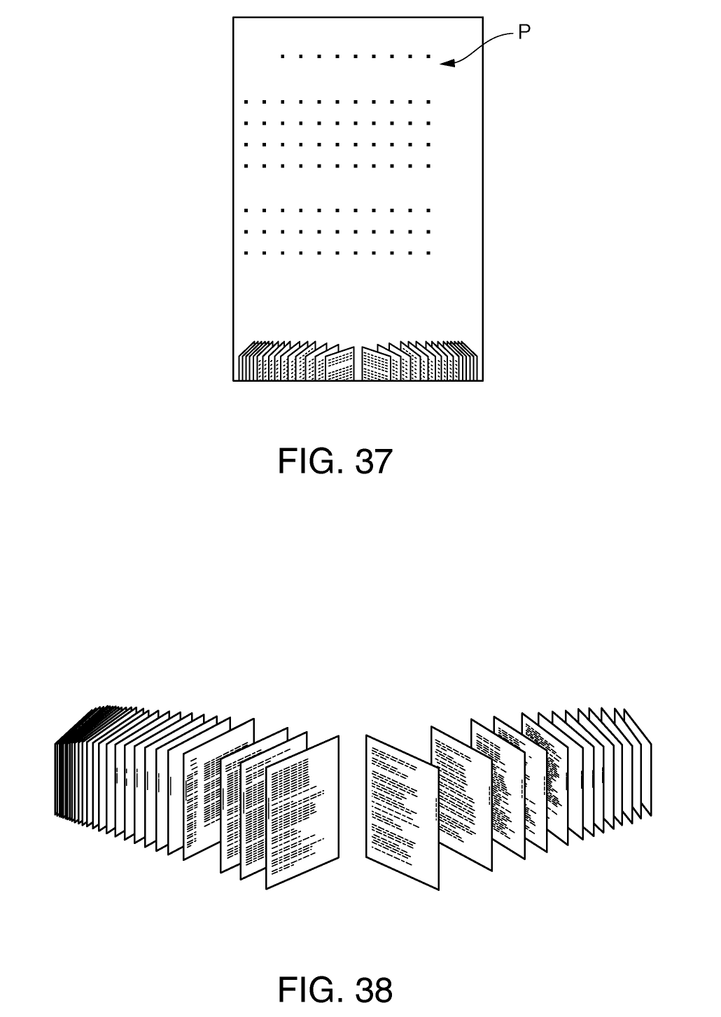

FIG. 36 shows diagrams exemplifying a state in which the process has advanced from the state shown in FIG. 35. In this state, the data in the VRAM 7 coincide with the gradation levels in the display section 1. Also, all the data stored in the write data memory regions are 0, indicating that the writing processing for the entire pixels has been completed.

In summary, the display section 1 includes a plurality of pixels; and by a display rewriting process, the gradation levels of the pixels are updated by a writing operation of applying voltages multiple times to the pixels. The display rewriting process includes the steps of comparing image data representative of an image to be newly displayed on the display section 1 with scheduled image data representative of an image scheduled to be displayed on the display section 1 by the write operation in progress, thereby judging pixels whose gradation is to be changed among the plurality of pixels (step S16), and the steps of starting the write operation for a pixel to reach a gradation level defined by the image data, when the pixel that is determined to be the pixel whose gradation is to be changed is not in the write operation, and starting the write operation for a pixel to reach a gradation level defined by the image data, after the write operation in progress is completed, when the pixel that is determined to be the pixel whose gradation is to be changed is in the write operation (step S23).

In accordance with the present embodiment, even when a region where rewriting has already started and a region where rewriting is to be newly started partially overlap each other, the rewriting is immediately started in a portion where rewriting is not in progress at the time of newly starting the rewriting. Therefore, the user feels that the display speed is faster. Also, in accordance with the present embodiment, it is possible to have pixels to which a positive voltage is applied and a negative voltage is applied coexisted in a single frame (a drive scheme in which a positive voltage and a negative voltage can both be selected in a single frame is called a “bipolar drive”).

### 3. Other Embodiments

The invention is not limited to the embodiments described above, and can be implemented in various modes. Some of modified examples will be described below. It is noted that two or more of the following modified examples may be combined.

### 3-1. MODIFIED EXAMPLE 1

When search results using a first search word and a second search word are to be displayed in a single screen, two tag images, i.e., a first tag image corresponding to the first search word and a second tag image corresponding to the second search word may be used. The process in this case is executed in a manner similar to the flow shown in FIG. 13. In step S300, the control section 3 obtains a second search subject. In the tag image generation process in step S320, the control section generates a second tag image different from the first tag image as a tag image corresponding to the second search subject. More specifically, if the display is in a state in which a search result for another search subject is already displayed when the control section 3 obtains the search subject in step S300, the control section 3 uses a second tag image, which is different from the first tag image, for the new search subject. The first tag image and the second tag image may be different from each other in their outline, size, color, and/or average gradation value of the image as a whole. According to such a configuration, the user can overlook search results using multiple search subjects at once.

### 3-2. MODIFIED EXAMPLE 2

Tag images are not limited to those described in the embodiments. For example, the tag image may not have to include an image of the search word. In another example, the tag image may not have to be added to a fixed position with respect to a thumbnail image, but at a potion corresponding to a row where the search word is found. In this case, if the search word is found at multiple locations in a single page, tag images may be added to the multiple locations in the single page. For example, when the search word is found in the 5^{th} row and the 10^{th} row in the 10^{th} page, tag images may be added to a position corresponding to the 5^{th} row and a position corresponding to the 10^{th} row in the 10^{th} page.

Also, in the embodiment described above, a tag image and a thumbnail image corresponding to the tag image are transformed using the same parameters (the angle of rotation θ and the like). However, parameters used for transformation of a tag image may be made different from parameters used for transformation of a thumbnail image. In another example, a tag image may be added to a thumbnail image without transformation.

### 3-3. MODIFIED EXAMPLE 3

FIG. 37 is a view showing an example of a display image in accordance with a modified example 3. Instead of displaying a thumbnail image group in its entirety, only a portion thereof may be displayed. In the example shown in FIG. 37, only a predetermined range from the upper end of a thumbnail image group, for example, only a top portion thereof is displayed, and a lower portion lower than the upper portion is not displayed.

### 3-4. MODIFIED EXAMPLE 4

FIG. 38 is a view showing an example of the arrangement of thumbnail images in accordance with a modified example 4. The arrangement of thumbnail images in a thumbnail image group is not limited to the one described in the embodiment above. Thumbnail images may be arranged from the right to the left of a display region in a descending order of their page numbers. Also, the positions of upper or lower sides of adjacent two thumbnail images may not have to match each other. In the example shown in FIG. 38, thumbnail images displayed on the left side of a thumbnail image of the first selected page are shifted gradually upward as they are placed farther away from the first selected page. Thumbnail images displayed on the right side of a thumbnail image corresponding to one page prior to the first selected page are shifted gradually upward as they are placed farther away from the thumbnail image corresponding to one page prior to the first selected page.

### 3-5. MODIFIED EXAMPLE 5

The size of a thumbnail image is not limited to those described in the embodiments. The size of a thumbnail image may be decided in advance. In another example, the size of a thumbnail image may be changed according to an instruction inputted by the user. In accordance with still another example, the size of a thumbnail image may be changed according to the resolution of the display section 1. This configuration is effective for a device with its display device being exchangeable, for example, in a case where the electronic apparatus 1000 is a personal computer or the like. Also, the size of thumbnail images may not have to be the same for all of the pages. More specifically, the thumbnail image of the first selected page may be made larger than thumbnail images of pages other than the first selected page. Also, the thumbnail image of the second selected page may be made larger than thumbnail images of pages before or after the second selected page. In another example, the thumbnail image of the first selected page may be the largest, and thumbnail images of other pages may be made gradually smaller as the pages are located farther away from the first selected page. In accordance with still another example, thumbnail images of pages in a predetermined range from the first selected page may have the same size as that of the first selected page, and thumbnail images of pages outside of the range may be made smaller than the thumbnail image of the first selected page.

### 3-6. MODIFIED EXAMPLE 6

Parameters set for generating a thumbnail image group are not limited to those described in the embodiment. For example, when the second selected page is located after the first selected page, the interval between the second selected page and its preceding pages may be made wider, and the interval between the second selected page and its succeeding pages may not be made wider. Alternatively, when the second selected page is located before the first selected page, the interval between the second selected page and its succeeding pages may be made wider, and the interval between the second selected page and its preceding pages may not be made wide. Also, the interval d between the thumbnail images may be set such that the interval between pages becomes narrower as the pages are positioned farther away from the thumbnail image of the first selected page. In another example, a wide interval may be used for thumbnail images of pages in a predetermined range extending from the first selected page such that they do not overlap each other.

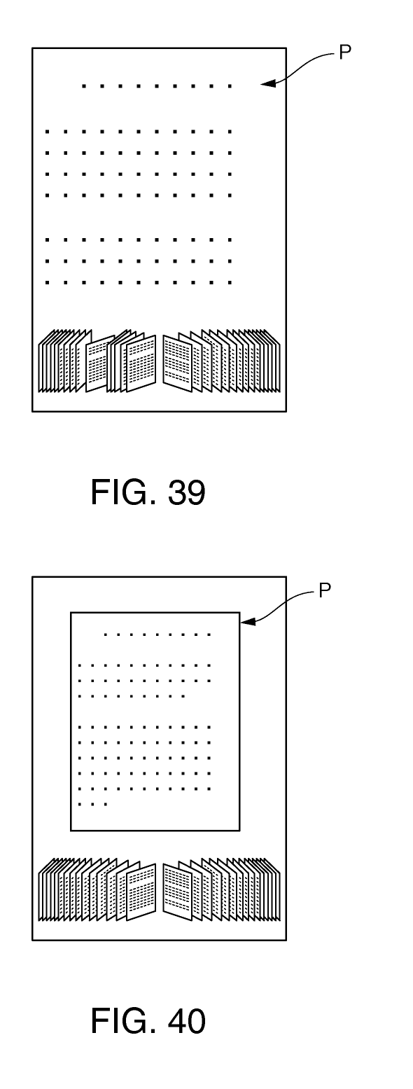

FIG. 39 is a view showing an example of a thumbnail image group in accordance with a modified example 6. A thumbnail image of the second selected page may have an angle of rotation smaller than that of thumbnail images before and after the second selected page. Also, in the embodiment described above, the thumbnail images of preceding pages of the first selected page are rotated about the rotation axis M in a rotation direction that is opposite to the rotation direction in rotating the thumbnail image of the first selected page. However, in the invention, thumbnail images of preceding pages of the first selected page may be rotated in a rotation direction that is the same as the rotation direction in rotating the thumbnail image of the first selected page. Also, in the invention, the angle of rotation θ may be 0°. Also, in the invention, the same angle of rotation may be set for each of the thumbnail images. Further, in the invention, thumbnail images of pages in a predetermined range extending from the first selected page may be rotated through the same angle of rotation as that of the thumbnail image of the first selected page, and thumbnail images of pages outside the predetermined range extending from the first selected page may be rotated through an angle of rotation greater than the angle of rotation of the thumbnail image of the first selected page.

### 3-7. MODIFIED EXAMPLE 7

FIG. 40 is a view showing an example of a thumbnail image group in accordance with a modified example 7. The positional relation between the thumbnail image group and the first selected page is not limited to the relation described in the embodiment. FIG. 40 shows an example in which a thumbnail image group and a first selected page are displayed in a manner not to overlap each other. In another example, a thumbnail image group P11 alone may be displayed without displaying a first selected image P. When a thumbnail image group P11 alone is displayed, the size of each of the thumbnail images may be made larger, compared to the case where the thumbnail image group is displayed together with the first selected page P.

### 3-8. MODIFIED EXAMPLE 8

The electronic apparatus 1000 may include a configuration that is capable of switching between display and non-display of thumbnail images. Switching between display and non-display may be performed, for example, according to an input instruction through the operation section 9. More specifically, when the button 9B is depressed, thumbnail images being displayed may be erased. When the button 9A is depressed in the state where no thumbnail image is displayed, thumbnail images may be displayed. For erasing thumbnail images, the thumbnail images may be scrolled down below the display region. For displaying thumbnail images, the thumbnail images may be scrolled upward from below the lower edge of the display region.

### 3-9. MODIFICATION EXAMPLE 9

The configuration of the operation section 9 is not limited to the configuration described in the embodiment. The operation section 9 may be provided with a position input device that obtains information of a position that is touched by a stylus pen at the display section 1. The electronic apparatus 1000 may obtain the position and locus of the stylus pen based on the positional information obtained by the position input device, and may control each of the sections of the electronic apparatus 1000 according to the position and locus obtained.

### 3-10. OTHER MODIFIED EXAMPLES

The electronic apparatus 1000 is not limited to an electronic book reader. The electronic apparatus 1000 may be a personal computer, a PDA (Personal Digital Assistant), a cellular phone, a smart phone, a tablet terminal, or a portable game console. In these electronic apparatuses, the functions shown in FIG. 6 may be realized through execution of a program by the control section 3. The program may be provided in a state being stored in computer-readable recording media, such as, magnetic recording media (for example, a magnetic tape, a magnetic disk (HDD (Hard Disk Drive), a FD (Flexible Disk) or the like), optical recording media (an optical disk (CD (Compact Disc), a DVD (Digital Versatile Disk) or the like), magneto-optic recording media, and semiconductor memories. In another example, the program may be downloaded onto the electronic apparatus 1000 through a communication line. Thus obtained program may be installed in the electronic apparatus 1000 and used.

The equivalent circuit of pixels is not limited to the equivalent circuit described in the embodiment. Switching elements and capacitance elements may be combined in any way, as long as a controlled voltage can be applied between the pixel electrodes 13a and the transparent electrode 32. Also, the method of driving the pixels is not limited to the bipolar drive method described in the embodiment. A single polar drive method in which voltages with a single polarity are applied to pixels in each single frame may be performed.

The structure of pixels is not limited to the structure described in the embodiment. For example, the polarities of charged particles are not limited to the polarities described in the embodiment. Black electrophoretic particles may be negatively charged, and white electrophoretic particles may be positively charged. In this case, the polarities of voltages to be applied to the pixels become inversed to the polarities described in the embodiment. Also, the display elements are not limited to electrophoretic type display devices using microcapsules. Other display elements, such as, liquid crystal elements, organic EL (Electro Luminescence) elements or the like may be used. In the embodiment, the display section 1 has the display function of displaying monochrome two gradation levels, but may be provided with a display function of displaying monochrome three or more gradation levels, or a color display function.

A part of the functions of the electronic apparatus 1000 shown in FIG. 6, or a part of the processings described with the flow chart of FIG. 7 may be omitted. For example, in the embodiment, an example in which the control section 3 generates thumbnail images from book data. However, the control section 3 may not have to generate thumbnail images. In this case, book data may include thumbnail images. The control section 3 may obtain thumbnail images from the book data. Tab images may be provided and obtained in a similar manner.

An image to be displayed on the display section 1 is not limited to an image of an electronic book. An image to be displayed on the display section 1 may be a thesis, a report, a document, a figure, a table, a photo, a web site, or the like. Also, an element that is subject to search is not limited to a word. Elements other than words, such as, images and the like may be searched.

The entire disclosure of Japanese Patent Application No. 2011-039880, filed Feb. 25, 2011 is expressly incorporated by reference herein.

What is claimed is:

1. A display control method comprising:
obtaining a plurality of thumbnail images for a document having a plurality of pages, the thumbnail images each presenting each of the plurality of pages reduced in size in a reference state, rotated about a virtual rotation axis as a center, and processed into a view overlooked from a certain viewpoint;
obtaining a first search subject;
obtaining a first tag image corresponding to the first search subject obtained; and
displaying a thumbnail image group on a display device, the thumbnail image group including the plurality of thumbnail images in a state in which at least two thumbnail images among the plurality of thumbnail images are partially overlapped each other and the first tag image is added to a thumbnail image of a page including the first search subject.

2. A display control method according to claim 1, wherein the tag image is processed so as to be rotated from the reference state through the same angle of rotation as that of the corresponding thumbnail image about the rotation axis of the thumbnail image, and into a view overlooked from the viewpoint of the thumbnail image.

3. A display control method according to claim 1, further comprising obtaining a second search subject, and obtaining a second tag image different from the first tag image,
the thumbnail image group including the second tag image added to a thumbnail image of a page that includes the second search subject.

4. A display control method according to claim 1, comprising receiving a selection of a first selected page from among the plurality of pages, and updating the thumbnail image group displayed on the display device upon receiving the selection,
an interval between a thumbnail image of the first selected page and a thumbnail image of a page before or after the first selected page in the thumbnail image group after update being wider than an interval between a thumbnail image of the first selected page and a thumbnail image of a page before or after the first selected page in the thumbnail image group before update.

5. A display control method according to claim 4, wherein the thumbnail image of the first selected page is positioned at the foremost plane among the thumbnail image group.

6. A display control method according to claim 5, wherein the thumbnail image of the first selected page is rotated about the virtual rotation axis as a center in a direction opposite to the direction of rotation of a thumbnail image of a page before or after the first selected page about the virtual rotation axis as a center.

7. A display control method according to claim 4, comprising receiving a selection of a second selected page from among the plurality of pages, and updating the thumbnail image group displayed on the display device upon receiving the selection,
an interval between a thumbnail image of the second selected page and a thumbnail image of a page before or after the second selected page in the thumbnail image group after update being wider than an interval between a thumbnail image of the second selected page and a thumbnail image of a page before or after the second selected page in the thumbnail image group before update.

8. A display control method according to claim 1, wherein the display device has a plurality of pixels, and changes the gradation of the pixels by a write operation of applying a voltage to the pixels multiple times, the display control method including the steps of comparing image data representative of an image to be newly displayed on the display device with scheduled image data representative of an image scheduled to be displayed on the display device by the write operation in progress, thereby judging pixels whose gradation is to be changed among the plurality of pixels, and the steps of starting the write operation for a pixel to reach a gradation defined by the image data, when the pixel that is determined to be the pixel whose gradation is to be changed is not in the write operation, and starting the write operation for a pixel to reach a gradation defined by the image data, after the write operation in progress is completed, when the pixel that is determined to be the pixel whose gradation is to be changed is in the write operation.

9. A display apparatus comprising:
a display device that displays an image;
a thumbnail image obtaining device that obtains a plurality of thumbnail images for a document having a plurality of pages, the thumbnail images each presenting each of the plurality of pages reduced in size in a reference state, rotated about a virtual rotation axis as a center, and processed into a view overlooked from a certain viewpoint;
a search subject obtaining device that obtains a first search subject;
a tag image obtaining device that obtains a first tag image corresponding to the first search subject; and
a display control device that displays a thumbnail image group on the display device, the thumbnail image group including the plurality of thumbnail images in a state in which at least two thumbnail images among the plurality of thumbnail images are partially overlapped each other and the first tag image is added to a thumbnail image of a page including the first search subject.

10. An electronic apparatus comprising the display device recited in claim 9.
